(19) United States
(12) Patent Application Publication
(10) Pub. No.: US 2016/0193533 A1
(43) Pub. Date: Jul. 7, 2016

(54) Information storage medium and terminal

(71) Applicant: BANDAI NAMCO Entertainment Inc., Tokyo (JP)

(72) Inventors: Shingo HIRAKAWA, Kashiwa-shi (JP); Yutaka FUKUMOTO, Tokyo (JP)

(21) Appl. No.: 14/757,546

(22) Filed: Dec. 23, 2015

(30) Foreign Application Priority Data
Dec. 26, 2014 (JP) 2014-265627

(51) Int. Cl. A63F 13/95

(52) U.S. Cl. CPC A63F 13/95

(57) ABSTRACT

A terminal receives a shape input that sequentially designates a predetermined number of player characters to form a predetermined shape, and forms the predetermined shape based on the shape input. When an enemy character is present within an area defined by the formed shape, the terminal performs a process that causes the designated player characters to attack the enemy character.

Japanese Patent Application No. 2014-265627, filed on Dec. 26, 2014, is hereby incorporated by reference in its entirety.

### BACKGROUND OF THE INVENTION

The present invention relates to an information storage medium and a terminal. A server system that provides a social networking service (SNS) (i.e., community-type service) to the user is known. Such a server system may also provide a social game (online game) to the user.

A social game that causes a character selected by the player and an enemy character to attack each other to determine whether or not the player has won the game is known (see JP-A-2013-059569). For example, a game screen may be divided into an upper screen and a lower screen. In such a case, a first game may be displayed within the lower screen, a second game is displayed within the upper screen, and the second game may proceed based on the results of the first game. The first game may be a mini-game (e.g., puzzle, coin pusher, or breakout) that can be played within one screen. The second game may be a role-playing game (RPG) that utilizes a character (card), wherein a player character and an enemy character battle each other based on a parameter comparison process.

However, a known battle game in which a player character attacks an enemy character may have a problem in that the player cannot enjoy strategic game play.

### SUMMARY

Several aspects of the invention may provide an information storage medium and a terminal that implement a game in which the player performs a shape input for forming a predetermined shape, and make it possible for the player to enjoy strategic game play.

According to a first aspect of the invention, there is provided a non-transitory computer-readable information storage medium storing a program that implements a game process that causes a plurality of player characters to battle with an enemy character, the program causing a computer to function as:

a placement section that places the player characters and the enemy character in a placement area;

a reception section that receives a shape input that sequentially designates a predetermined number of player characters among the plurality of player characters to form a predetermined shape;

a determination section that determines whether or not the predetermined shape has been formed based on the shape input;

an enemy character control section that controls movement of the enemy character;

an enemy character determination section that determines whether or not the enemy character is present within an area defined by the formed shape; and

a battle processing section that performs a process that causes the designated player characters to attack the enemy character when the enemy character is present within the area.

According to a second aspect of the invention, there is provided a terminal that implements a game process that causes a plurality of player characters to battle with an enemy character, the terminal including:

a placement section that places the player characters and the enemy character in a placement area;

a reception section that receives a shape input that sequentially designates a predetermined number of player characters among the plurality of player characters to form a predetermined shape;

a determination section that determines whether or not the predetermined shape has been formed based on the shape input;

an enemy character control section that controls movement of the enemy character;

an enemy character determination section that determines whether or not the enemy character is present within an area defined by the formed shape; and

a battle processing section that performs a process that causes the designated player characters to attack the enemy character when the enemy character is present within the area.

### BRIEF DESCRIPTION OF THE SEVERAL VIEWS OF THE DRAWING

FIG. 1 is a diagram illustrating a game system according to one embodiment of the invention.

FIG. 2 is a functional block diagram illustrating an example of a terminal according to one embodiment of the invention.

FIG. 3 is a functional block diagram illustrating an example of a server according to one embodiment of the invention.

FIG. 4 illustrates an example of a game screen according to one embodiment of the invention.

FIG. 5 illustrates an input determination area according to one embodiment of the invention.

FIG. 6 illustrates a process that forms a triangle according to one embodiment of the invention.

FIG. 7 illustrates an example of information about a player character.

FIG. 8 illustrates an example of information about an enemy character.

FIG. 9 illustrates a process that forms a triangle and a process that determines whether or not an enemy character is present within an area, according to one embodiment of the invention.

FIGS. 10A and 10B illustrate a process that determines whether or not an enemy character is present within an area.

FIG. 11 illustrates an example of a game screen according to one embodiment of the invention.

FIG. 12 illustrates a time limit-related process according to one embodiment of the invention.

FIG. 13 illustrates an example of a game screen according to one embodiment of the invention.

FIG. 14 illustrates the area and the length of each side of a triangle, etc. according to one embodiment of the invention.

FIGS. 15A and 15B illustrate a process that forms a triangle according to one embodiment of the invention.

FIGS. 16A to 16C are flowcharts illustrating the flow of a process according to one embodiment of the invention.

FIG. 17 is a flowchart illustrating the flow of a process that forms a triangle.

FIG. 18 illustrates an application example of a process that forms a triangle.

FIG. 19 illustrates an application example of an input determination area.

FIGS. 20A and 20B illustrate other examples of a predetermined shape.

FIGS. 21A to 21D illustrate a process that forms a triangle according to one embodiment of the invention.

FIG. 22 illustrates an example of a process that attacks a plurality of enemy characters according to one embodiment of the invention.

### DETAILED DESCRIPTION OF THE EMBODIMENT

(1) According to one embodiment of the invention, a non-transitory computer-readable information storage medium stores a program that implements a game process that causes a plurality of player characters to battle with an enemy character, the program causing a computer to function as:

a placement section that places the player characters and the enemy character in a placement area;

a reception section that receives a shape input that sequentially designates a predetermined number of player characters among the plurality of player characters to form a predetermined shape;

a determination section that determines whether or not the predetermined shape has been formed based on the shape input;

an enemy character control section that controls movement of the enemy character;

an enemy character determination section that determines whether or not the enemy character is present within an area defined by the formed shape; and

a battle processing section that performs a process that causes the designated player characters to attack the enemy character when the enemy character is present within the area.

Another embodiment of the invention relates to a terminal that includes the above sections.

According to the above configuration, the player performs the shape input that sequentially designates a predetermined number of player characters to form the predetermined shape (e.g., triangle), and the designated player characters attack the enemy character when the enemy character is present within an area defined by the formed shape. Specifically, since the player must carefully designate the player characters and perform the shape input so as to surround the enemy character, it is possible to provide a deep and strategic game.

(2) In each of the information storage medium and the terminal, a time for receiving the shape input may be limited corresponding to each of the player characters, and the reception section may receive the shape input within the limited time corresponding to the designated player characters.

According to this configuration, since the player must perform the shape input within the limited time corresponding to the designated player characters, it is possible to urge the player to promptly perform the shape input (i.e., encourage a feeling of tension), and provide an interesting game. Since the player must carefully designate the player characters taking account of the limited time corresponding to each player character, it is possible to provide a more strategic game.

Note that the limited time corresponding to the designated player characters may be the limited time corresponding to one of the designated player characters that has been designated first, or may be the limited time corresponding to any one of the designated player characters. The limited time corresponding to the designated player characters may also be the total of the limited time corresponding to some or all of the designated player characters.

(3) In each of the information storage medium and the terminal, the reception section may start to count the limited time when the determination section has determined that the first shape has been formed.

According to this configuration, the player can perform the shape input with no time limit until it is determined that the first shape has been formed. When it has been determined that the first shape has been formed, the limited time is counted, and the player must perform the shape input within the limited time. Specifically, the player can carefully perform the shape input until it is determined that the first shape has been formed, but must promptly perform the shape input with a feeling of tension after it has been determined that the first shape has been formed. This makes it possible to provide a more strategic and interesting game.

Specifically, the player can reliably form the first predetermined shape without fail (i.e., the player is satisfied). Since the shape input is received on condition that the time limit has not been reached when the player forms the second or subsequent shape, the player's skill is reflected when the player forms the second or subsequent shape. This makes it possible to provide a game that prevents or suppresses a situation in which the player gets tired of the game.

(4) In each of the information storage medium and the terminal, a position of one of the designated player characters that has been designated first may be a starting point, and when the determination section has determined that the first shape has been formed by the shape input, the reception section may repeatedly receive the shape inputs having the same starting point within the limited time.

According to this configuration, since the shape inputs having the same starting point are repeatedly received within the limited time when it has been determined that the first shape has been formed, the player can quickly perform the shape inputs having the same starting point when forming a plurality of shapes.

(5) In each of the information storage medium and the terminal, when the shape input has been suspended before the determination section determines that the first shape has been formed, the reception section may cancel the shape input that has been performed before the suspension.

According to this configuration, when the player has suspended the shape input before it is determined that the first shape has been formed, the shape input that has been performed before the suspension is canceled. Therefore, the player can perform the shape input again and again until the first shape is formed to form the desired shape.

(6) In each of the information storage medium and the terminal, the enemy character control section may reduce the moving speed of the enemy character when a first input that designates one of the player characters has been received, and stop the enemy character when the determination section has determined that the first shape has been formed.

According to this configuration, since the moving speed of the enemy character is reduced when a first input that designates one of the player characters has been received, the player can easily perform the shape input so as to surround the enemy character after performing a first input that designates one of the player characters. Since the enemy character is stopped when it has been determined that the first shape has been formed, the player can easily perform the shape input so as to reliably surround the enemy character after it has been determined that the first shape has been formed.

(7) In the information storage medium, the program may cause the computer to further function as a parameter control section that changes at least one of the attack capability of the player character and the attack capability of the enemy character based on the area of the formed shape.

The terminal may further include a parameter control section that changes at least one of the attack capability of the player characters and the attack capability of the enemy character based on the area of the formed shape.

According to this configuration, since at least one of the attack capability of the player characters and the attack capability of the enemy character is changed (e.g., the attack capability of the player characters is increased, or the attack capability of the enemy character is decreased) based on the area of the formed shape, the player must perform the shape input taking account of the area of the formed shape. This makes it possible to provide a more strategic game.

(8) In the information storage medium, the program may cause the computer to further function as a parameter control section that changes at least one of the attack capability of the player characters and the attack capability of the enemy character based on the total length of the sides of the formed shape.

The terminal may further include a parameter control section that changes at least one of the attack capability of the player characters and the attack capability of the enemy character based on the total length of the sides of the formed shape.

According to this configuration, since at least one of the attack capability of the player characters and the attack capability of the enemy character is changed (e.g., the attack capability of the player character is increased, or the attack capability of the enemy character is decreased) based on the total length of the sides of the formed shape, the player must perform the shape input taking account of the total length of the sides of the formed shape. This makes it possible to provide a more strategic game.

(9) In the information storage medium, the program may cause the computer to further function as a parameter control section that changes at least one of the attack capability of the player characters and the attack capability of the enemy character based on the type of the formed shape.

The terminal may further include a parameter control section that changes at least one of the attack capability of the player characters and the attack capability of the enemy character based on the type of the formed shape.

According to this configuration, since at least one of the attack capability of the player characters and the attack capability of the enemy character is changed (e.g., the attack capability of the player character is increased, or the attack capability of the enemy character is decreased) based on the type of the formed shape, the player must perform the shape input taking account of the type of the formed shape. This makes it possible to provide a more strategic game.

(10) In the information storage medium, the program may cause the computer to further function as a parameter control section that changes at least one of the attack capability of the player characters and the attack capability of the enemy character when a plurality of shapes have been formed and the enemy character is present within the overlapping area of the plurality of shapes.

The terminal may further include a parameter control section that changes at least one of the attack capability of the player characters and the attack capability of the enemy character when a plurality of shapes have been formed and the enemy character is present within the overlapping area of the plurality of shapes.

According to this configuration, since at least one of the attack capability of the player characters and the attack capability of the enemy character is changed (e.g., the attack capability of the player character is increased, or the attack capability of the enemy character is decreased) when a plurality of shapes have been formed and the enemy character is present within the overlapping area of the plurality of shapes, the player must perform a plurality of shape inputs so that the enemy character is present within the overlapping area of a plurality of shapes. This makes it possible to provide a more strategic game.

Exemplary embodiments of the invention are described below. Note that the following exemplary embodiments do not unduly limit the scope of the invention as stated in the claims. Note also that all of the elements described below in connection with the exemplary embodiments should not necessarily be taken as essential elements of the invention.

### 1. Game System

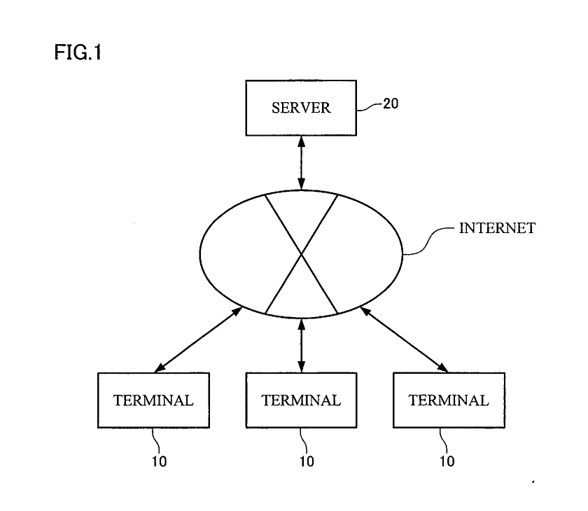

FIG. 1 illustrates a game system (network system) according to one embodiment of the invention. The game system according to one embodiment of the invention includes a plurality of terminals 10 and a server 20 (server system). As illustrated in FIG. 1, the game system according to one embodiment of the invention is configured so that the server 20 that provides a service and the terminals 10 can be connected to a network (e.g., the Internet).

The server 20 is an information processing device that provides a service that allows a plurality of users (players) to communicate with each other. In one embodiment of the invention, the server 20 provides a community-type service that is referred to as “social networking service (SNS)”. Specifically, the server 20 transmits user information (e.g., user name, diary, notice information, and game field state) to a user who has logged in, as well as another user who maintains a friendship with the user who has logged in, so that these users can communicate with each other. The server 20 may provide the service to only users who have registered themselves as a member. The server 20 may be implemented by a single server, or may be implemented by a plurality of servers (e.g., authentication server, game processing server, communication server, accounting server, and database server).

The server 20 according to one embodiment of the invention provides an online game service (social game) in response to a request from the terminal 10. In one embodiment of the invention, the terminal 10 executes a game program, and the server 20 manages account information about each player, information about the results of the game executed by the terminal 10, game media (e.g., character and item) that can be used in the game, and in-game money that can be used in the game, information about each stage of the game, and the like.

The terminal 10 is an information processing device such as a portable terminal (e.g., smartphone, mobile phone, or portable game machine), a personal computer (PC), a game device, or an image generation device, and can connect to the server 20 through a network (e.g., the Internet (WAN) and LAN). Note that the terminal 10 and the server 20 may be connected through a cable communication channel, or may be connected through a wireless communication channel. The terminal may be referred to as “game terminal”.

### 2. Configuration

### 2.1 Configuration of Terminal

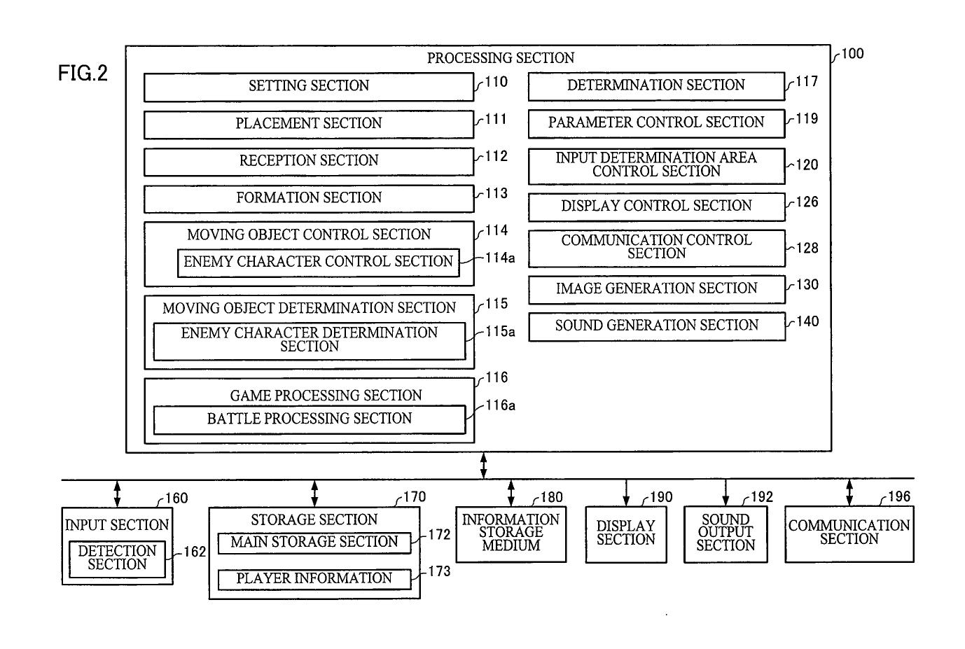

FIG. 2 illustrates an example of a functional block diagram of the terminal 10 (game device) according to one embodiment of the invention. Note that the terminal according to one embodiment of the invention may have a configuration in which some of the elements (sections) illustrated in FIG. 2 are omitted.

An input section 160 is a device that detects information (input information) input by the player, and outputs the information (input information) input by the player to a processing section 100. The function of the input section 160 may be implemented by an input device such as a touch panel, a touch pad, a mouse, a trackball, a direction key, a button, or a keyboard. For example, a detection section 162 detects a touch input (touch operation) performed by the player from a touch detection area (touch panel). The player can perform a shape input using the input section 160. For example, when the input section 160 is a touch panel, the player can perform a shape input by performing a slide operation.

A storage section 170 stores a program that causes a computer to function as each section of the processing section 100, as well as various types of data, and serves as a work area for the processing section 100. The function of the storage section 170 may be implemented by a hard disk, a RAM, or the like.

The storage section 170 also stores information (e.g., type, parameter, attribute, and level) about a character that is possessed by the player (that can be used by the player), setting information about a character that has been set to be a player character (setting player character) (the setting information about the character that has been set to be the player character (setting player character) may be referred to as “deck information”), information about an item that is possessed by the player, and information about in-game money and the like as player information 173.

Note that an attribute and a parameter (e.g., attack capability, strength value, and shape input time limit) are set to each player character. In one embodiment of the invention, the player character is an example of a selection target object (hereinafter the same).

The storage section 170 also stores various types of data such as information (e.g., parameter, attribute, and level) about an enemy character, information about each stage of the game, and information about an enemy character that appears at each stage. In one embodiment of the invention, the enemy character is an example of a moving object (hereinafter the same).

An information storage medium 180 is a computer-readable medium. The information storage medium 180 stores the program, data, and the like. The function of the information storage medium 180 may be implemented by an optical disk (e.g., DVD or CD), a hard disk drive (HDD), a memory (e.g., ROM), or the like. The processing section 100 performs various processes according to one embodiment of the invention based on a program (data) stored in the information storage medium 180. Specifically, a program that causes a computer (terminal) to function as each section according to one embodiment of the invention (i.e., a program that causes a computer to execute the process of each section) is stored in the information storage medium 180.

A display section 190 outputs a game image generated by the processing section 100. The function of the display section 190 may be implemented by a display (e.g., touch panel display, LCD, or CRT). The display section 190 may include the input section 160 (e.g., touch panel).

A sound output section 192 outputs sound generated by the processing section 100. The function of the sound output section 192 may be implemented by a speaker, headphones, or the like.

A communication section 196 performs various control processes for communicating with the server 20. The function of the communication section 196 may be implemented by hardware such as a processor or a communication ASIC, a program, or the like.

Note that the terminal 10 may receive a program and data that are stored in an information storage medium or a storage section included in the server 20 via a network, and store the received program and data in the storage section 170 or the information storage medium 180. A case where the terminal 10 receives a program and data that cause a computer to function as each section of the processing section 100 is also included within the scope of the invention.

The processing section 100 (processor) performs a game process, an image generation process, a sound generation process, and the like based on the input information (operation input) from the input section 160, a program, data received through the communication section 196, and the like. The function of the processing section 100 may be implemented by hardware such as a processor (e.g., CPU or DSP) or an ASIC (e.g., gate array), or a program.

The processing section 100 includes a setting section 110, a placement section 111, a reception section 112, a formation section 113, a moving object control section 114, a moving object determination section 115, a game processing section 116, a determination section 117, a parameter control section 119, an input determination area control section 120, a display control section 126, a communication control section 128, an image generation section 130, and a sound generation section 140.

The setting section 110 performs a deck setting process. For example, the setting section 110 sets twelve characters (player characters) to be a deck. For example, nine characters among the twelve characters may be characters possessed by the player, one character among the twelve characters may be a character possessed by a friend of the player, and two characters among the twelve characters may be characters linked to the stage. Specifically, the setting section 110 sets nine characters (selected by the player from a plurality of characters that are possessed by the player (that can be used by the player)) to be the deck based on the input information from the input section 160. Note that the term “deck” used herein refers to a pack of setting player characters used for the game.

The placement section 111 places a plurality of selection target objects and a moving object in a placement area. More specifically, the placement section 111 places a plurality of player characters and an enemy character within the placement area. For example, the placement section 111 places six player characters among twelve player characters set to be the deck within the placement area.

The reception section 112 receives the input information from the input section 160. More specifically, the reception section 112 receives the input information based on a slide operation performed within a touch detection area. Note that the term “slide operation” used herein refers to an operation performed by the player that touches a touch panel with a fingertip, a touch pen, or the like, moves the fingertip or the like without removing the fingertip or the like from the touch panel, and then removes the fingertip or the like from the touch panel. The reception section 112 may receive the input information through a pointing device (e.g., mouse or trackball).

The reception section 112 acquires the input position (touch position), the input direction (touch direction), and the input amount (touch amount) during the input period (touch period) detected by the input section 160 based on a slide operation or the like as the input information.

The reception section 112 receives the touch position detected from the touch panel as the input position (two-dimensional instruction position). The reception section 112 acquires the input position that has been input in a predetermined cycle (e.g., every 1/60th of a second). Note that the input position may be two-dimensional position coordinates indicated by a mouse (i.e., input section) or the like. In such a case, the reception section 112 receives the position coordinates during a period in which the player presses the button of the mouse, moves (drags) the mouse while pressing the button, and releases the button of the mouse.

The reception section 112 according to one embodiment of the invention receives an input that sequentially designates a plurality of selection target objects for forming a triangle (i.e., an input (e.g., slide operation) that continuously designates the positions of the plurality of selection target objects) from the plurality of selection target objects placed within the placement area.

More specifically, the reception section 112 receives a designation input that designates a player character among the plurality of player characters. The reception section 112 may sequentially receive a designation input that designates a player character among the plurality of player characters when an input position has been detected within the input determination area of the player character.

The reception section 112 receives a shape input that forms (inputs) a predetermined shape. For example, the reception section 112 may receive a shape input that forms a predetermined shape by sequentially designating a predetermined number of (e.g., three) player characters.

For example, the reception section 112 receives an input that sequentially designates a plurality of player characters for forming a triangle from the plurality of player characters placed within the placement area. Specifically, the reception section 112 may receive an input that designates a plurality of player characters in an arbitrary order.

The reception section 112 may receive the shape input within a time that is limited corresponding to the designated player characters. For example, the reception section 112 may start to count the limited time when the determination section 117 has determined that the first shape has been formed. In one embodiment of the invention, a time for receiving the shape input is limited corresponding to each player character.

A position of one of the designated player characters that has been designated first may be a starting point, and when the determination section 117 has determined that the first shape has been formed by the shape input, the reception section 112 repeatedly receives the shape inputs having the same starting point within the limited time.

When the shape input has been suspended (terminated) before the determination section 117 determines that the first shape has been formed, the reception section 112 may cancel the shape input that has been performed before the suspension (termination).

The formation section 113 forms a predetermined shape based on the shape input. For example, the formation section 113 forms a triangle with vertices that respectively correspond to the positions of the selection target objects designated by the reception section 112.

Specifically, the formation section 113 forms a triangle with vertices that respectively correspond to the positions of the first selection target object, the second selection target object, and the third selection target object that have been sequentially designated by the player. For example, the formation section 113 forms a triangle with vertices that respectively correspond to the positions of the first player character, the second player character, and the third player character that have been sequentially designated by the player.

When the angle formed by a line that connects the first selection target object that has been designated first and the second selection target object that has been designated after the first selection target object, and a line that connects the first selection target object and the third selection target object that has been designated after the second selection target object, is equal to or smaller than a predetermined angle, and the reception section 112 has received an input that designates a selection target object (fourth selection target object) other than the first selection target object and the second selection target object after receiving an input that designates the third selection target object, the formation section 113 forms a triangle with vertices that respectively correspond to the positions of the first selection target object, the third selection target object, and the fourth selection target object instead of the positions of the first selection target object, the second selection target object, and the third selection target object. For example, when the angle formed by a line that connects the first player character that has been designated first and the second player character that has been designated after the first player character, and a line that connects the first player character and the third player character that has been designated after the second player character, is equal to or smaller than a predetermined angle, and the fourth player character has been designated after the third player character, the formation section 113 forms a triangle with vertices that respectively correspond to the positions of the first player character, the third player character, and the fourth player character instead of the positions of the first player character, the second player character, and the third player character.

When the second selection target object that has been designated after the first selection target object is present within a determination area that is set to extend along a line that connects the first selection target object that has been designated first and the third selection target object that has been designated after the second selection target object, and the reception section 112 has received an input that designates a selection target object (fourth selection target object) other than the first selection target object and the second selection target object after receiving an input that designates the third selection target object, the formation section 113 may form a triangle with vertices that respectively correspond to the positions of the first selection target object, the third selection target object, and the fourth selection target object instead of the positions of the first selection target object, the second selection target object, and the third selection target object. For example, when the second player character that has been designated after the first player character is present within a determination area that is set to extend along a line that connects the first player character that has been designated first and the third player character that has been designated after the second player character, and the reception section 112 has received an input that designates the fourth player character after receiving an input that designates the third player character, the formation section 113 may form a triangle with vertices that respectively correspond to the positions of the first player character, the third player character, and the fourth player character instead of the positions of the first player character, the second player character, and the third player character.

When the angle formed by a line that connects the first selection target object that has been designated first and the second selection target object that has been designated after the first selection target object, and a line that connects the first selection target object and the third selection target object that has been designated after the second selection target object, is equal to or smaller than a predetermined angle, the second selection target object is present within a determination area that is set to extend along a line that connects the first selection target object and the third selection target object, and the reception section 112 has received an input that designates a selection target object (fourth selection target object) other than the first selection target object and the second selection target object after receiving an input that designates the third selection target object, the formation section 113 may form a triangle with vertices that respectively correspond to the positions of the first selection target object, the third selection target object, and the fourth selection target object instead of the positions of the first selection target object, the second selection target object, and the third selection target object.

For example, when the angle formed by a line that connects the first player character that has been designated first and the second player character that has been designated after the first player character, and a line that connects the first player character and the third player character that has been designated after the second player character, is equal to or smaller than a predetermined angle, the second player character is present within a determination area that is set to extend along a line that connects the first player character and the third player character, and the reception section 112 has received an input that designates a player character (fourth player character) other than the first player character and the second player character after receiving an input that designates the third player character, the formation section 113 may form a triangle with vertices that respectively correspond to the positions of the first player character, the third player character, and the fourth player character instead of the positions of the first player character, the second player character, and the third player character.

The moving object control section 114 controls the movement of the moving object. For example, the moving object control section 114 may reduce the moving speed of the moving object when an input that designates the first selection target object has been received, and stop the moving object when the determination section 117 has determined that the first shape has been formed.

The moving object control section 114 includes an enemy character control section 114a. The enemy character control section 114a controls the movement of the enemy character. For example, the enemy character control section 114a may reduce the moving speed of the enemy character when an input that designates the first player character has been received, and stop the enemy character when the determination section 117 has determined that the first shape has been formed.

The moving object determination section 115 determines whether or not the moving object is present within an area defined by the shape formed by the player. For example, the moving object determination section 115 determines whether or not the moving object is present within an area defined by a triangle formed by the player.

The moving object determination section 115 includes an enemy character determination section 115a. The enemy character determination section 115a determines whether or not the enemy character is present within an area defined by the shape formed by the player. For example, the enemy character determination section 115a determines whether or not the enemy character is present within an area defined by a triangle formed by the player.

The game processing section 116 performs a game process. For example, the game processing section 116 performs a predetermined game process based on the determination result of the moving object determination section 115.

The game processing section 116 may determine whether or not to assign a new player character to the player based on the progress level (e.g., the login count, the game play count, the elapsed time from the last login to the current login, the number of stages cleared, and the elapsed time) of the game.

The game processing section 116 includes a battle processing section 116a. The battle processing section 116a performs a game process that causes the player character to battle with the enemy character. For example, the battle processing section 116a performs a game process that executes a battle between the player character (that has been set to be the deck (as the setting player character) and the enemy character that appears at a stage selected by the player, and determines whether or not the player has cleared the stage based on the battle results.

When the enemy character is present within an area defined by the shape (e.g., triangle) formed by the player, the battle processing section 116a performs a process that causes the player characters that respectively correspond to the vertices of the triangle to attack the enemy character. Specifically, the battle processing section 116a performs a process that causes the designated player characters to attack the enemy character. The battle processing section 116a performs a process that causes the designated player characters to attack the enemy character when the enemy character is present within an area defined by the shape formed by the player.

The determination section 117 determines whether or not a predetermined shape (e.g., triangle) has been formed based on the shape input.

The parameter control section 119 controls the parameter (e.g., game parameter such as the strength value and the attack capability) of at least one of the player character and the enemy character.

For example, the parameter control section 119 may change at least one of the attack capability of the player character and the attack capability of the enemy character based on the area (area value) of the shape formed by the player.

The parameter control section 119 may change at least one of the attack capability of the player character and the attack capability of the enemy character based on the total length of the sides of the shape formed by the player.

The parameter control section 119 may change at least one of the attack capability of the player character and the attack capability of the enemy character based on the type of the shape formed by the player.

The parameter control section 119 may change at least one of the attack capability of the player character and the attack capability of the enemy character when a plurality of shapes have been formed, and the enemy character is present within the overlapping area of the plurality of shapes. For example, the parameter control section 119 may increase the attack capability of the player character when a plurality of shapes have been formed, and the enemy character is present within the overlapping area of the plurality of shapes.

Note that the parameter control section 119 may perform a process that synthesizes (blends) one character (base character) with another character (material character). Specifically, the parameter control section 119 may reduce the number of characters possessed by the players through synthesis, and increase (enhance) the parameter of the base character.

The input determination area control section 120 sets an input determination area for each selection target object based on the position of each selection target object. For example, the input determination area control section 120 sets the input determination area for each player character based on the position of each player character.

The input determination area control section 120 may deform the input determination area of each selection target object other than the selection target object that has been designated based on the position of the selection target object that has been designated and each selection target object other than the selection target object that has been designated. For example, the input determination area control section 120 may deform the input determination area of each player character other than the player character that has been designated based on the position of the player character that has been designated and each player character other than the player character that has been designated.

The input determination area control section 120 may narrow the input determination area of each selection target object other than the selection target object that has been designated along a line that connects the position of the selection target object that has been designated and each selection target object other than the selection target object that has been designated. For example, the input determination area control section 120 may narrow the input determination area of each player character other than the player character that has been designated along a line that connects the position of the player character that has been designated and each player character other than the player character that has been designated.

The display control section 126 displays the game screen on the display section 190. For example, the display control section 126 displays an object (i.e., character (e.g., player character and enemy character)).

The display control section 126 according to one embodiment of the invention displays the player character and the enemy character that are placed within the placement area.

The display control section 126 may delete the player character for which the strength value has reached a predetermined value (e.g., 0) from the placement area.

The communication control section 128 exchanges data with the server 20 or another terminal 10 through a network. When the communication control section 128 transmits data to the server 20 or another terminal 10, the communication control section 128 transmits identification information about the player (or identification information about the terminal) together with the data so that the server 20 or the other terminal 10 can specify the player (terminal) who (that) has transmitted the received data.

For example, the communication control section 128 transmits game start notification information to the server 20 when the game has started, and transmits information about the game result and various game parameters to the server 20 when the game has ended.

The communication control section 128 may transmit information about the characters possessed by the player that is stored in the storage section 170, information (deck information) about the player characters that have been set to be the setting player characters, information about the placement of the player characters, information about an item possessed by the player, information about in-game money, and the like to the server 20.

The communication control section 128 may transmit the information about the characters possessed by the player that is stored in the storage section 170, the information (deck information) about the player characters that have been set to be the setting player characters, the information about the placement of the player characters, the information about an item possessed by the player, the information about in-game money, and the like to the server 20 when the information has been changed.

The image generation section 130 performs a drawing process based on the results of various processes performed by the processing section 100 to generate a game image (i.e., a game image that includes the player character, the enemy character, information that corresponds to the determination result, and the like), and outputs the generated game image to the display section 190. The image generation section 130 may generate an image (i.e., three-dimensional image) viewed from a virtual camera (given viewpoint) within an object space (game space).

The sound generation section 140 performs a sound process based on the results of various processes performed by the processing section 100 to generate a game sound (e.g., background music (BGM), effect sound, or voice), and outputs the generated game sound to the sound output section 192.

### 2.2 Configuration of Server

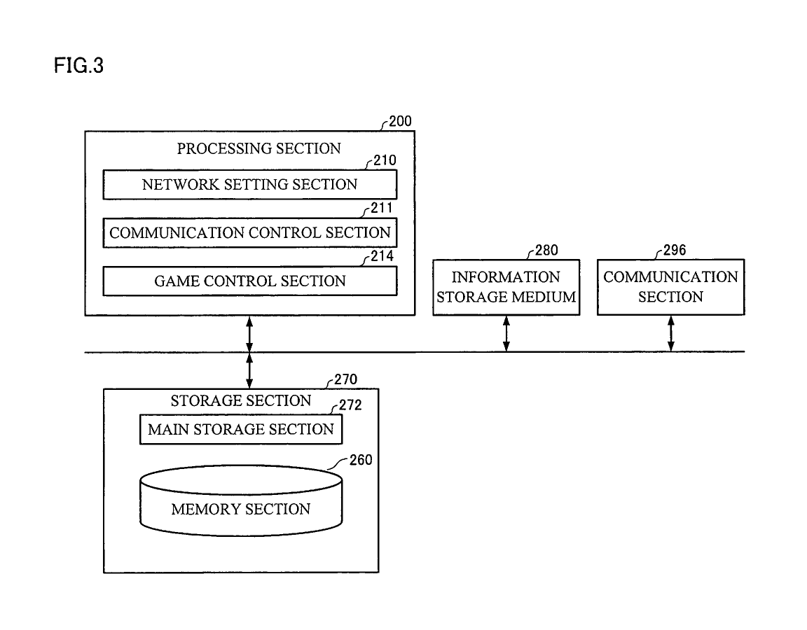

FIG. 3 illustrates an example of a functional block diagram of the server 20 according to one embodiment of the invention. Note that the server 20 may have a configuration in which some of the elements (sections) illustrated in FIG. 3 are omitted.

A storage section 270 serves as a work area for a processing section 200, a communication section 296, and the like. The function of the storage section 270 may be implemented by a RAM (VRAM) or the like. The storage section 270 includes a main storage section 272 and a memory section 260 (e.g., database).

The memory section 260 may store a player password, an e-mail address, charge information, and the like so as to be linked to terminal identification information or player identification information (user account and user identification information) about each terminal that is managed by the server 20.

An information storage medium 280 (computer-readable medium) stores a program, data, and the like. The function of the information storage medium 280 may be implemented by an optical disk (CD or DVD), a magneto-optical disk (MO), a magnetic disk, a hard disk, a magnetic tape, a memory (ROM), or the like. The processing section 200 performs various processes according to one embodiment of the invention based on a program (data) stored in the information storage medium 280. Specifically, a program that causes a computer to function as each section according to one embodiment of the invention (i.e., a program that causes a computer to execute the process of each section) is stored in the information storage medium 280.

The communication section 296 performs various control processes for communicating with the outside (e.g., terminal, another server, or another game system). The function of the communication section 296 may be implemented by hardware such as a processor or a communication ASIC, a program, or the like. The processing section 200 (processor) performs a process based on a program stored in the information storage medium 280, for example. More specifically, the processing section 200 provides a service in response to a request from each terminal.

The processing section 200 performs various processes using the main storage section 272 included in the storage section 270 as a work area. The function of the processing section 200 may be implemented by hardware such as a processor (e.g., CPU or DSP) or an ASIC (e.g., gate array), or a program.

The processing section 200 included in the server 20 according to one embodiment of the invention includes a network setting section 210, a communication control section 211, and a game control section 214. Note that the processing section 200 may have a configuration in which some of the network setting section 210, the communication control section 211, and the game control section 214 are omitted.

The network setting section 210 receives the player identification information or the terminal identification information from the terminal 10, and stores network information about the player in the memory section 260 so as to be linked to the received player identification information or terminal identification information.

The communication control section 211 exchanges data with the terminal 10 via a network. Specifically, the communication control section 211 transmits information corresponding to a request to the terminal 10 based on a request from the terminal 10 possessed (operated) by each player.

The communication control section 211 receives the identification information about the player (or the identification information about the terminal) from the terminal 10. Specifically, the server can determine the player (terminal) who (that) has transmitted the received information. When the server transmits information about one player to the terminal of another player, the server transmits the identification information about the one player (or the identification information about the terminal) together with the information about the one player. Specifically, the terminal can determine the player (terminal) to whom (which) the information received from the server relates.

The communication control section 211 may receive the game result from the terminal 10 after the game has ended.

The game control section 214 performs various game control processes. For example, the game control section 214 stores the player information (e.g., the information about the characters possessed by the player, the setting information (deck information) about the characters that have been set to be the setting player characters, the information about an item possessed by the player, and the information about in-game money and the like in the storage section 270 (memory section 260) of the server for each player.

The game control section 214 updates the player information (e.g., the information about the characters possessed by the player, the setting information (deck information) about the characters that have been set to be the setting player characters, the placement of the characters, the information about an item possessed by the player, and the information about in-game money and the like) when information that represents that the information has been changed has been received from the terminal 10.

The game control section 214 performs a process that receives information (e.g., game result) transmitted from the terminal 10 (game device), and updates various types of information linked to each player based on the received information.

The game control section 214 may receive the input information from each terminal, and perform a parameter (e.g., attack capability) calculation process based on the received input information to determine the game result.

Note that the processing section 200 of the server 20 according to one embodiment of the invention may perform part or the entirety of the process performed by the processing section 100 of the terminal 10.

### 3. Method

### 3.1 Outline

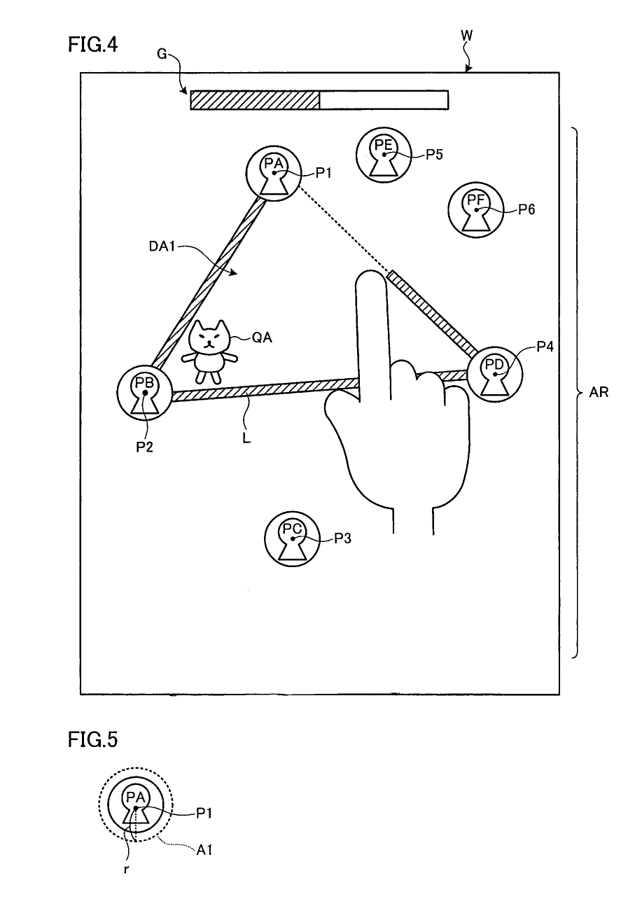

The game according to one embodiment of the invention is designed so that player characters battles with an enemy character. FIG. 4 illustrates an example of a game screen (game image) according to one embodiment of the invention. A game screen W is displayed on the display section 190 (i.e., a display that includes a touch panel) of the terminal 10. The player can perform an operation input by performing a touch input (touch operation) (i.e., touching the touch panel) with a fingertip, a touch pen, or the like.

The game screen W illustrated in FIG. 4 includes a placement area AR in which the enemy character and the player characters are placed. As illustrated in FIG. 4, at least three player characters and at least one enemy character are placed within the placement area AR. In one embodiment of the invention, the position of each player character is fixed, and the enemy character is moved and stopped during the game.

When the game (dungeon) has started, and the player's turn has come, the player performs an input (e.g., slide operation) that forms a triangle with vertices that respectively correspond to the positions of arbitrary player characters so as to surround an enemy character QA. For example, the player forms a triangle along a locus indicated by a line L.

When the enemy character QA is present within (an area defined by (hereinafter the same)) a triangle with vertices that respectively correspond to the positions of player characters PA, PB, and PD, an attack process that decreases the strength value of the enemy character QA based on the attack capability of the player characters PA, PB, and PD is performed.

One embodiment of the invention thus provides a deep and strategic game that employs a simple rule that the player attacks the enemy character by surrounding the enemy character with a plurality of player characters.

### 3.2 Process that Forms a Triangle

In one embodiment of the invention, the designation (selection) of arbitrary player characters is received based on a slide operation to form a triangle with vertices that respectively correspond to the designated player characters.

In one embodiment of the invention, an input determination area is set for each player character placed within the placement area based on the position of each player character, and an input that designates each player character is received when a touch operation (touch input) has been detected within the input determination area. As illustrated in FIG. 5, a circle that is formed around the position P1 of the player character PA placed within the placement area and has a radius r is set to be an input determination area A1, and an input that designates the player character PA is received when a touch operation has been detected within the input determination area A1, for example.

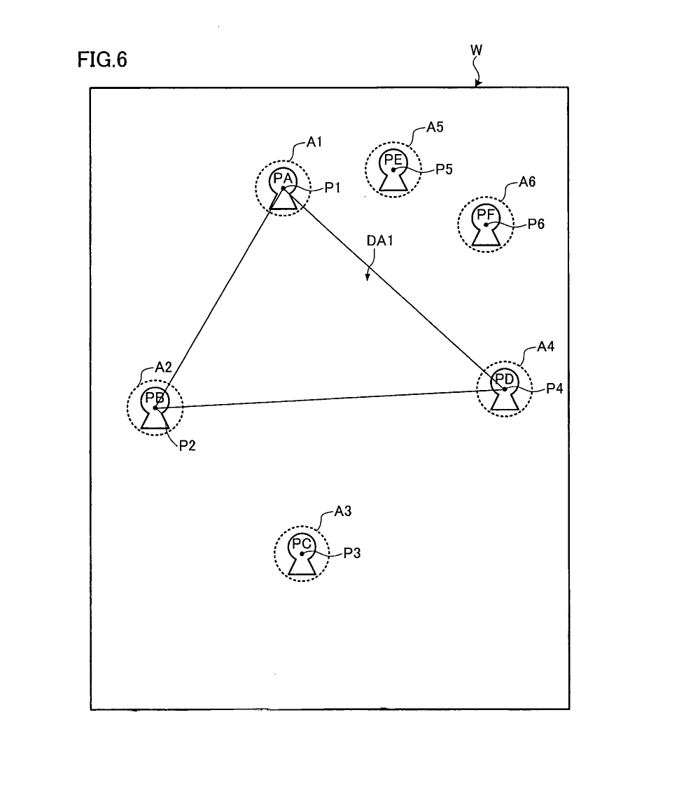

As illustrated in FIG. 6, the input determination areas A1, A2, A3, A4, A5, and A6 are respectively set based on the positions P1, P2, P3, P4, P5, and P6 of the player characters PA, PB, PC, PD, PE, and PF, for example. When a touch operation has been initially detected within the input determination area A1, the player character PA is determined to be the first player character that has been designated. When a touch operation has then been detected within the input determination area A2, the player character PB is determined to be the second player character that has been designated. When a touch operation has then been detected within the input determination area A4, the player character PD is determined to be the third player character that has been designated.

When the player characters PA, PB, and PD have thus sequentially been designated, a triangle DA1 with vertices that respectively correspond to the positions (points) P1, P2, and P4 of the player characters PA, PB, and PD is formed.

In one embodiment of the invention, a process that forms (completes (finalizes)) the triangle DA1 is performed at a timing at which a final input has been received (performed) after the third player character has been designated.

For example, the process that forms (completes) the triangle DA1 is performed when the player has designated the third player character PD, and then performed a slide operation that touches the input determination area A1 of the player character PA that was designated first (i.e., performed the final input). The game according to one embodiment of the invention thus allows the player to form a triangle using three player characters so as to surround the enemy character. Note that the triangle DA1 may be formed at a timing at which an input that designates the third player character PD has been received, or may be formed at a timing at which a predetermined input that corresponds to the final input has been received.

As illustrated in FIG. 4, a triangle with vertices that respectively correspond to the positions of the first player character, the second player character, and the third player character may be displayed in a first color (e.g., blue) after the third player character has been designated. When a triangle has been formed (completed), the triangle may be displayed in the first color, or may be displayed in a third color (e.g., green) that differs from the first color.

The locus L formed when the player is performing an input (slide operation) may be displayed in a second color (e.g., yellow) to display a triangle that is being formed to the player (guide display).

### 3.3 Player Character

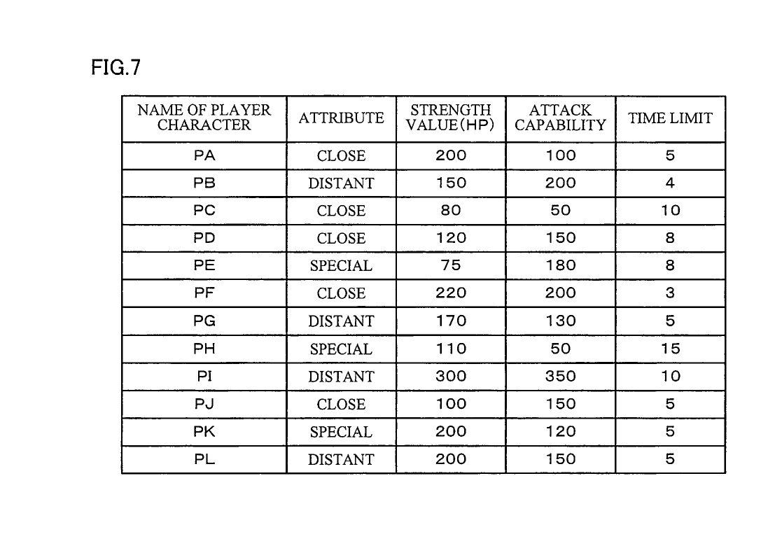

In one embodiment of the invention, parameters (e.g., attribute, strength value (HP value), attack capability, and time limit) are set to each player character so as to be linked to the identification information (e.g., name of player character) about each player character (see FIG. 7).

In one embodiment of the invention, the attribute is set in advance to each player character. The attribute is information that represents characteristics, an ability, and the like. For example, the attribute may be information that corresponds to the type of attack (e.g., “close”, “distant”, and “special”).

The strength value is a parameter that is used to determine whether the player character or the enemy character has won the game. The player character or the enemy character for which the strength value has reached 0 is determined to have lost the game.

The attack capability is a parameter that is used for a battle process. The attack capability is subtracted from the strength value of the opposing character that is attacked.

The time limit is a time limit for an input that forms a triangle. In one embodiment of the invention, a time limit is not set for an input that forms the first triangle, and a time for receiving an input that forms the second or subsequent triangle is limited corresponding to one of the designated player characters that has been designated first. Specifically, when the player desires to form the second or subsequent triangle, the player must perform an input that forms the second or subsequent triangle within the limited time.

An item (piece of equipment) may be set in advance to each player character prior to the start of the game (not illustrated in the drawings). For example, a given parameter value changes when the item has been used.

In one embodiment of the invention, twelve characters are set to be the deck (player characters) prior to the start of the game.

For example, the twelve characters that are set to be the deck include nine characters that are possessed by the player, one character that is possessed by a friend of the player, and two characters that are provided in advance and linked to the stage.

### 3.4 Enemy Character

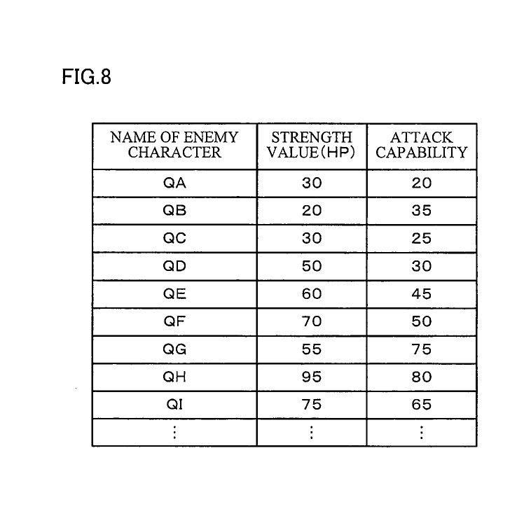

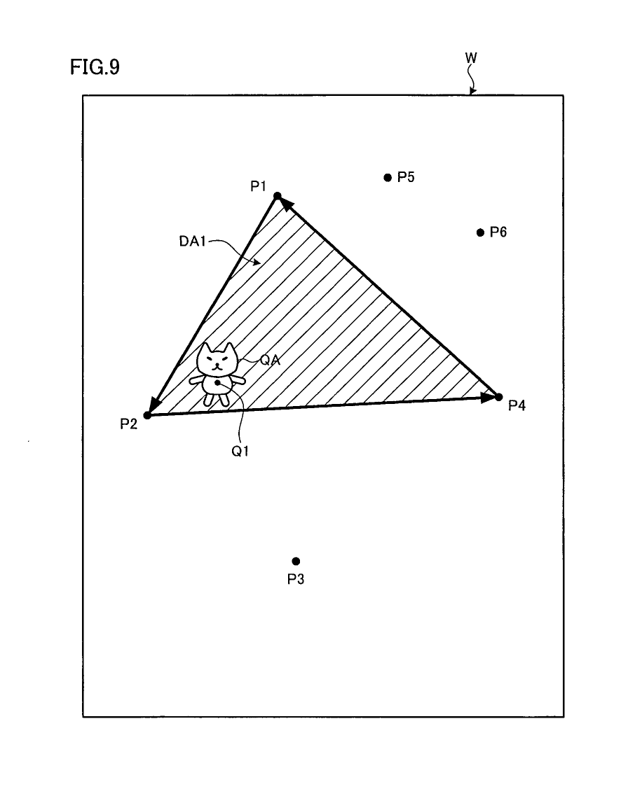

FIG. 8 illustrates information (e.g., parameter) about the enemy character. The strength value (HP value) and the attack capability are set in advance to the enemy character. The attribute and the item may be set to the enemy character in the same manner as the player character (not illustrated in the drawings).

### 3.5 Battle Game

The process performed during the battle game according to one embodiment of the invention is described below. In one embodiment of the invention, when the player has formed a triangle by performing an operation input, whether or not the enemy character is present within the triangle is determined. When the enemy character is present within the triangle, the player characters that surround the enemy character attack the enemy character. This process is performed as one unit. A process that causes the enemy character to attack the player character is also performed as one unit. The process is performed so that the battle game proceeds using each unit as one turn (game unit).

For example, when the player's turn has come, six player characters are randomly extracted from the twelve player characters that are set to be the deck, and placed within the placement area (see FIG. 4). The six player characters are placed within the placement area at positions determined in advance based on a computer program. Note that the positions of the six player characters may be determined based on an operation input performed by the player. As illustrated in FIG. 4, the player sequentially designates the player characters PA, PB, and PD by performing a slide operation to form the triangle DA1 with vertices that respectively correspond to the positions (points) P1, P2, and P4 of the player characters PA, PB, and PD, for example.

The enemy character moves within the placement area during the player's turn. The moving direction and the moving speed are set in advance to the enemy character.

In one embodiment of the invention, the moving speed of the enemy character is reduced at a timing at which the designation of the first player character has been received. The moving speed of the enemy character is reduced so that the player can easily perform a slide operation that surrounds the enemy character. The enemy character is stopped when the first triangle DA1 has been formed (completed).

In one embodiment of the invention, when the player has removed his/her finger from the screen (touch panel) (i.e., has suspended (terminated) the slide operation (touch operation)) before the first triangle DA1 is formed, the slide operation that has been performed before the suspension is canceled. Specifically, the player can try to form a triangle again and again until the triangle DA1 is formed. Note that the number of player's turns does not decrease when the slide operation has been suspended (terminated) before the first triangle DA1 is formed. Specifically, the player's turn is maintained when the slide operation has been suspended (terminated) before the first triangle DA1 is formed.

When the triangle DA1 has been formed, whether or not the enemy character QA is present within the triangle DA1 is determined (see FIG. 9). For example, whether or not the position Q1 of the enemy character QA is present within the triangle DA1 is determined. When the position Q1 of the enemy character QA is present within the triangle DA1, it is determined that the enemy character QA is present within the triangle DA1. When the position Q1 of the enemy character QA does not lie within the triangle DA1, it is determined that the enemy character QA does not lie within the triangle DA1.

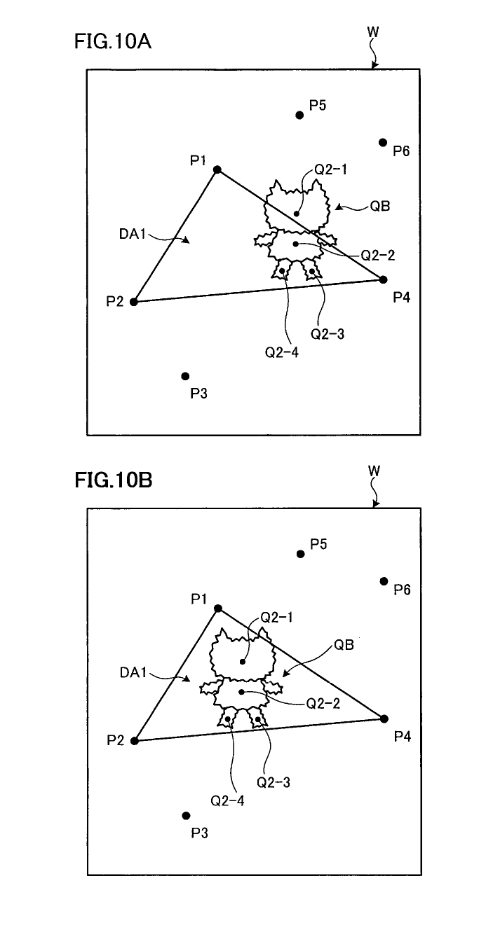

As illustrated in FIGS. 10A and 10B, when the enemy character is a large enemy character QB, a plurality of determination points Q2-1, Q2-2, Q2-3, and Q2-4 are set to the enemy character QB. Tt is determined that the enemy character QB is present within the triangle DA1 when at least one of the determination points set to the enemy character QB is present within the triangle DA1. Note that it may be determined that the enemy character QB is present within the triangle DA1 when at least a predetermined number of determination points lie within the triangle DA1.

In the example illustrated in FIG. 10A, it is determined that the enemy character QB is present within the triangle DA1 since the determination points Q2-2, Q2-3, and Q2-4 set to the enemy character QB lie within the triangle DA1. In the example illustrated in FIG. 10B, it is determined that the enemy character QB is present within the triangle DA1 since the determination points Q2-1, Q2-2, Q2-3, and Q2-4 set to the enemy character QB lie within the triangle DA1.

Again referring to FIG. 9, when the enemy character QA is present within the triangle DA1, the process that causes the player characters PA, PB, and PD that correspond to the vertices (P1, P2, and P4) of the triangle DA1 to attack the enemy character QA is performed.

Specifically, a process that subtracts the attack capability of each of the player characters PA, PB, and PD that surround the enemy character from the strength value of the enemy character is performed. When a defense capability is set to the enemy character, the defense capability of the enemy character is subtracted from the attack capability of each player character, and the resulting value (damaging capability) is subtracted from the strength value of the enemy character.

When a plurality of determination points are set to the enemy character (see the enemy character QB illustrated in FIGS. 10A and 10B), the attack capability of each player character may be changed based on the number of determination points that lie within the triangle DA1. For example, the ratio x of the number of determination points that lie within the triangle DA1 to the total number of determination points is calculated, and the attack capability of each player character is multiplied by the value x. In the example illustrated in FIG. 10A, since three determination points among the four determination point lie within the triangle DA1, the attack capability of each of the player characters PA, PB, and PD that surround the enemy character QB is multiplied by 0.75, and subtracted from the strength value of the enemy character QB. In the example illustrated in FIG. 10B, since all of the four determination points lie within the triangle DA1, the attack capability of each of the player characters PA, PB, and PD that surround the enemy character QB is multiplied by 1, and subtracted from the strength value of the enemy character QB.

According to one embodiment of the invention, since the player attacks the enemy character by forming a triangle so as to surround the enemy character, the player can enjoy playing the game strategically by determining (designating) the player characters that are used to form a triangle.

The enemy character's turn comes upon completion of the player's turn. In one embodiment of the invention, the enemy character's turn may come upon completion of a predetermined number of (one or more) player's turns, or the player's turn and the enemy character's turn may come alternately.

When the enemy character's turn has come, a process that causes the enemy character to attack the attack target player character is performed. The enemy character may attack all of the player characters situated within the placement area, or may attack only some of the player characters situated within the placement area.

An attack process that subtracts the attack capability of the enemy character from the strength value of the attack target player character is then performed. When a defense capability is set to the player character, the defense capability of the player character is subtracted from the attack capability of the enemy character, and the resulting value (damaging capability) is subtracted from the strength value of the player character.

The enemy character is deleted when the strength value of the enemy character has reached 0 (i.e., predetermined value). A predetermined number of (e.g., five) enemy characters participate in one battle game, and the next enemy character is sequentially placed within the placement area when the current enemy character has been deleted.

In one embodiment of the invention, the player's turn and the enemy character's turn thus come alternately, and whether or not the player has won the game is determined based on the strength value (HP value) of each player character and the strength value of each enemy character.

For example, it is determined that the player has won the game and the enemy character has lost the game when the strength value of all the enemy characters that appear in one battle game has reached 0 before the strength value of all the player characters set to be the deck reaches 0.

It is determined that the player has lost the game and the enemy character has won the game when the strength value of all the player characters set to be the deck has reached 0 before the strength value of all the enemy characters that appear in one battle game reaches 0.

Specifically, the total strength value of the player characters and the total strength value of the enemy characters are compared, and it is determined that the player has won the game and the enemy character has lost the game when the total strength value of the enemy characters has reached 0 before the total strength value of the player characters reaches 0, and vice versa.

As illustrated in FIG. 4, a gauge G that represents the strength value of the enemy character is displayed in the upper part of the screen W so that the player can check the strength value of the enemy character during the game. Note that a gauge that represents the strength value of each player character may be displayed at a position around each player character (not illustrated in the drawings).

### 3.6 Process that Forms a Plurality of Triangles

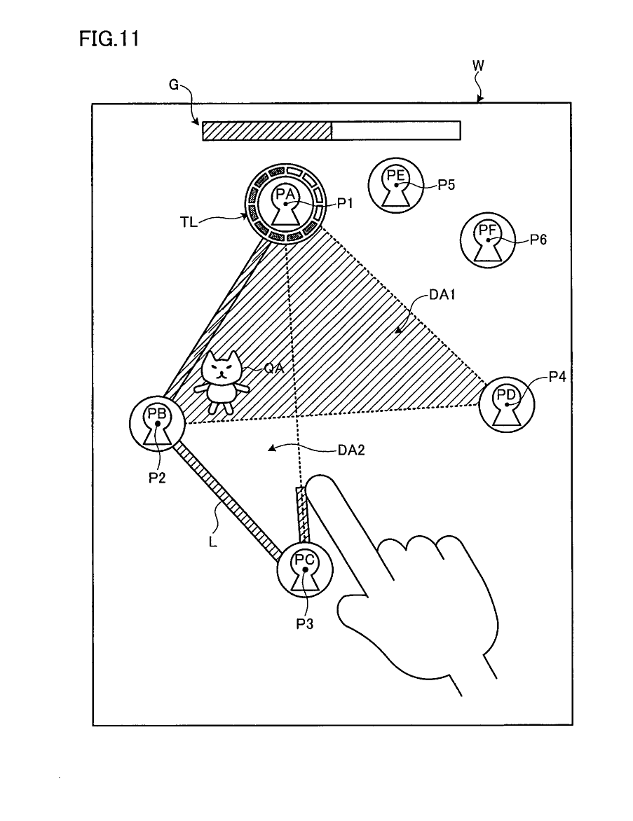

In one embodiment of the invention, the player can form a plurality of triangles. As illustrated in FIG. 11, an input that forms the second or subsequent triangle is received in the player's turn within the limited time corresponding to the player character PA that was designated first from the timing at which the first triangle DA1 was formed (completed), for example. Specifically, since the player must perform an operation input within the limited time when the player desires to form the second or subsequent triangle, it is possible to urge the player to promptly perform an operation input (i.e., encourage a feeling of tension), and provide a more interesting game.

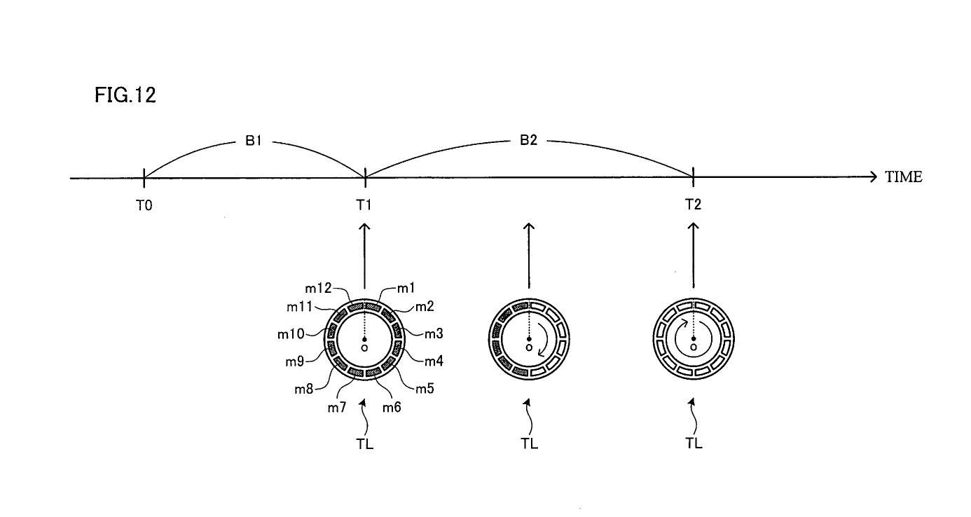

In one embodiment of the invention, the remaining time is counted (measured) from the timing at which the first triangle DA1 was formed (completed). As illustrated in FIG. 12, a time limit is not set for a period B1 from a player's turn start timing T0 to a timing T1 at which the first triangle DA1 is formed. The time limit corresponding to the player character PA that was designated first is set for an input that designates the player characters that are used to form the second or subsequent triangle. Specifically, since the time limit corresponding to the player character that is designated first (i.e., the player character that is initially designated), is set for an input that forms the second or subsequent triangle, the player can enjoy strategic game play (e.g., by initially designating the player character to which a long time limit is set).

For example, when the limited time corresponding to the player character PA is 5 seconds, the remaining time is counted from the timing T1 at which the first triangle DA1 was formed (see FIG. 12). Specifically, an input that designates the player character used to form a triangle is not received when 5 seconds has elapsed from the timing T1. Specifically, the player can reliably form one triangle in the player's turn, but the player's operation skill is reflected when the player forms the second or subsequent triangle. This makes it possible to provide a game that prevents or suppresses a situation in which the player gets tired of the game.

Since the enemy character is stopped when the first triangle DA1 has been formed (completed), the player can easily perform a slide operation so as to surround the enemy character when forming the second or subsequent triangle.

As illustrated in FIG. 11, a gauge TL that represents the remaining time is displayed around the player character PA that was designated first. As illustrated in FIG. 12, twelve squares m1 to m12 are provided to the gauge TL, for example. The remaining time is displayed in red, and the elapsed time is displayed in white so that the player can easily determine the remaining time in which the player can perform an input.

In one embodiment of the invention, when the player has removed his/her finger from the screen (touch panel) (i.e., has suspended (terminated) the slide operation (touch operation)) after the first triangle DA1 has been formed, but before the second (or subsequent) triangle is formed, an input that designates the player character is not received even when the time limit has not been reached. According to this configuration, since the player cannot try to form the second or subsequent triangle again and again, it is possible to prompt the player to play the game more strategically (e.g., by forming (completing) the first triangle while taking account of the formation of the second or subsequent triangle). Note that the player's turn is terminated, and the attack process is performed when the player has suspended (terminated) the slide operation that forms the second or subsequent triangle after the first triangle DA1 has been formed.

A plurality of triangles can be formed in the player's turn using the position of the player character PA that was designated first as the starting point. Specifically, the position of the player character PA that was designated first is used as the starting point for surrounding the enemy character, and is used as the first vertex when forming a triangle. Specifically, when the player forms a plurality of triangles, the position of the player character that was designated first is used as one of the vertices of each of the plurality of triangles. In one embodiment of the invention, the player cannot form a plurality of triangles that are identical as to the position of each vertex.

Whether or not the enemy character is present within each triangle that has been formed in the player's turn (until the time limit is reached, or until the player terminates the slide operation) is determined, and the attack process is performed for each triangle when the enemy character is present within each triangle.

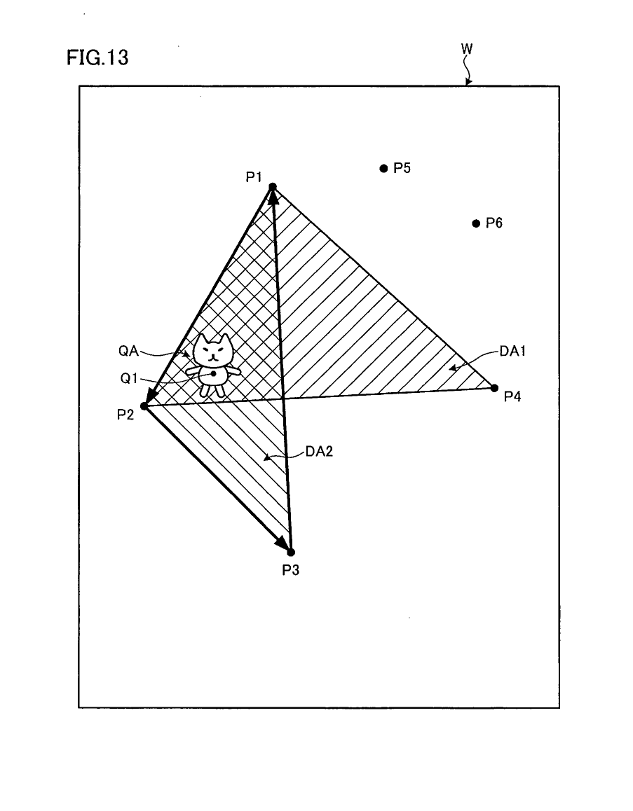

FIG. 13 illustrates an example in which the player has formed the first triangle DA1, and then sequentially designated the player characters PA, PB, and PC by performing a slide operation to form a triangle DA2 with vertices that respectively correspond to the positions (points) P1, P2, and P3 of the player characters PA, PB, and PC.

In this case, whether or not the enemy character QA is present within each of the triangles DA1 and DA2 is determined. When the enemy character QA is present within the triangle DA1, the process that causes the player characters PA, PB, and PD that correspond to the vertices (P1, P2, and P4) of the triangle DA1 to attack the enemy character QA is performed. When the enemy character QA is present within the triangle DA2, the process that causes the player characters PA, PB, and PC that correspond to the vertices (P1, P2, and P3) of the triangle DA2 to attack the enemy character QA is performed.

Note that a special value (initial value: 0) may be provided in advance, a value calculated by subtracting 1 from the number of triangles that have been formed may be added to the special value each time the player's turn has come, and a special skill program (e.g., a process that subtracts a special attack capability (e.g., 1,000) from the strength value of the enemy character) may be executed when the special value has become equal to or larger than a predetermined value (e.g., 10 or more). The special value is returned to the initial value after the skill program has been executed. This makes it possible to motivate the player to form a plurality of triangles, and provide a more interesting game.

When the player has formed a plurality of triangles in the player's turn, whether or not the enemy character is situated in the overlapping area of the plurality of triangles may be determined. When the enemy character is situated in the overlapping area of the plurality of triangles, the attack capability of the player character that corresponds to each vertex of each triangle may be increased (e.g., by a factor of 1.5). According to this configuration, since the player can increase the attack capability by forming a larger number of triangles that surround the enemy character, the player can enjoy strategic game play while taking account of measures to form a larger number of triangles.

### 3.7 Example of Change in Attack Capability

In one embodiment of the invention, the attack capability (attack capability value) of each player character when the player character attacks the enemy character may be changed based on at least one of the area and the total length of the sides of the triangle formed by the player.

For example, the attack capability of each player character may be changed based on the area of the triangle formed by the player. In one embodiment of the invention, the attack capability (attack capability value) of each player character is increased as the area of the triangle formed by the player decreases. For example, the attack capability of each player character is multiplied by 1 when the area of the triangle formed by the player is equal to or larger than a first predetermined value (e.g., equal to or larger than 100), is multiplied by 2 when the area of the triangle formed by the player is less than the first predetermined value and equal to or larger than a second predetermined value (e.g., less than 100 and equal to or larger than 50), and is multiplied by 3 when the area of the triangle formed by the player is less than the second predetermined value and equal to or larger than a third predetermined value (e.g., less than 50 and equal to or larger than 0).

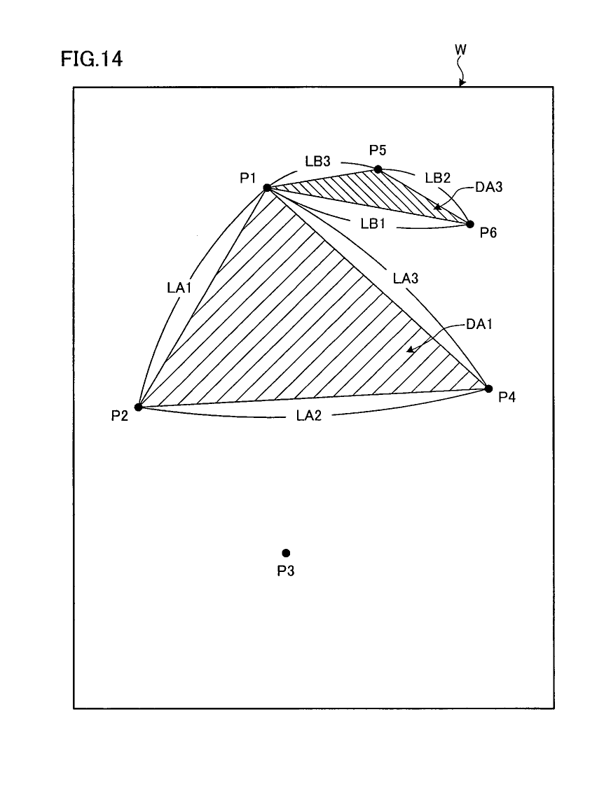

For example, when the area of the triangle DA1 is 80, and the area of a triangle DA3 is 10 (see FIG. 14), the attack capability increases when the enemy character is present within the player characters that form the triangle DA3 as compared with the case where the enemy character is present within the player characters that form the triangle DA1. Specifically, it is possible to provide an interesting game by employing a configuration in which it becomes difficult to surround the enemy character, but the attack capability increases as the area of the triangle decreases.

The attack capability of each player character may also be changed based on the total length of the sides of the triangle formed by the player. In one embodiment of the invention, the attack capability (attack capability value) of each player character is increased as the total length of the sides of the triangle formed by the player decreases. For example, the attack capability of each player character is multiplied by 1 when the total length of the sides of the triangle formed by the player is equal to or larger than a first predetermined value (e.g., equal to or larger than 100), is multiplied by 2 when the total length of the sides of the triangle formed by the player is less than the first predetermined value and equal to or larger than a second predetermined value (e.g., less than 100 and equal to or larger than 50), and is multiplied by 3 when the total length of the sides of the triangle formed by the player is less than the second predetermined value and equal to or larger than a third predetermined value (e.g., less than 50 and equal to or larger than 0).

For example, when the total value of the lengths LA1, LA2, and LA3 of the sides of the triangle DA1 is 80, and the total value of the lengths LB1, LB2, and LB3 of the sides of the triangle DA3 is 10 (see FIG. 14), the attack capability increases when the enemy character is present within the player characters that form the triangle DA3 as compared with the case where the enemy character is present within the player characters that form the triangle DA1. Specifically, it is possible to provide an interesting game by employing a configuration in which it becomes difficult to surround the enemy character, but the attack capability increases as the total length of the sides of the triangle decreases.

The attack capability of each player character may also be changed based on the attribute of each player character that has been designated to form a triangle. For example, when the attribute of the player character that has been designated to form a triangle is “close”, the attack capability of the player character is decreased as at least one of the area and the total length of the sides of the triangle formed by the player increases. For example, the attack capability of each player character is multiplied by 0.5 when at least one of the area and the total length of the sides of the triangle formed by the player is equal to or larger than a first predetermined value (e.g., equal to or larger than 100), is multiplied by 0.75 when the at least one of the area and the total length of the sides of the triangle formed by the player is less than the first predetermined value and equal to or larger than a second predetermined value (e.g., less than 100 and equal to or larger than 50), and is multiplied by 1 when the at least one of the area and the total length of the sides of the triangle formed by the player is less than the second predetermined value and equal to or larger than a third predetermined value (e.g., less than 50 and equal to or larger than 0).

For example, when the attribute of the player character that has been designated to form a triangle is “distant”, the attack capability of the player character may be maintained independently of the area and the total length of the sides of the triangle formed by the player.

For example, when the attribute of the player character that has been designated to form a triangle is “special”, a given value (e.g., 100) may be added to the attack capability of the player character independently of the area and the total length of the sides of the triangle formed by the player.

According to this configuration, since the player must play the game while taking account of the attribute of each player character, the player can enjoy more strategic game play.

When the attack capability is affected by either or both of the area and the total length of the sides of the triangle formed by the player, the locus L formed when the player is performing an input (slide operation) may be changed in thickness (width) based on either or both of the area and the total length of the sides of the triangle formed by the player.

For example, the locus L formed when the player is performing an input (slide operation) may be represented using a thick (wide) line when either or both of the area and the total length of the sides of the triangle formed by the player are small, and may be represented using a thin (narrow) line when either or both of the area and the total length of the sides of the triangle formed by the player are large.

### 3.8 Detailed Description of Process that Forms Triangle

In one embodiment of the invention, the designation of arbitrary player characters is received based on a slide operation performed by the player on the display screen that includes the touch detection area (touch panel) to form a triangle having a predetermined shape.

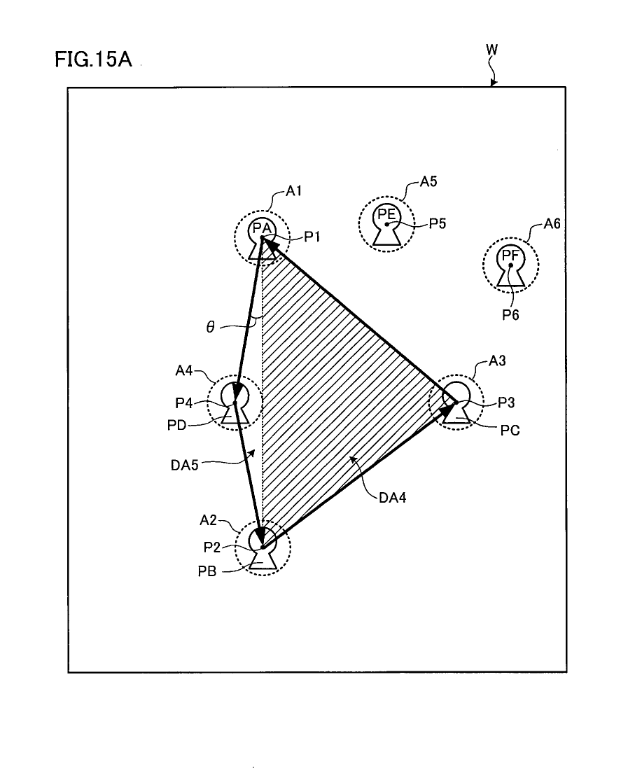

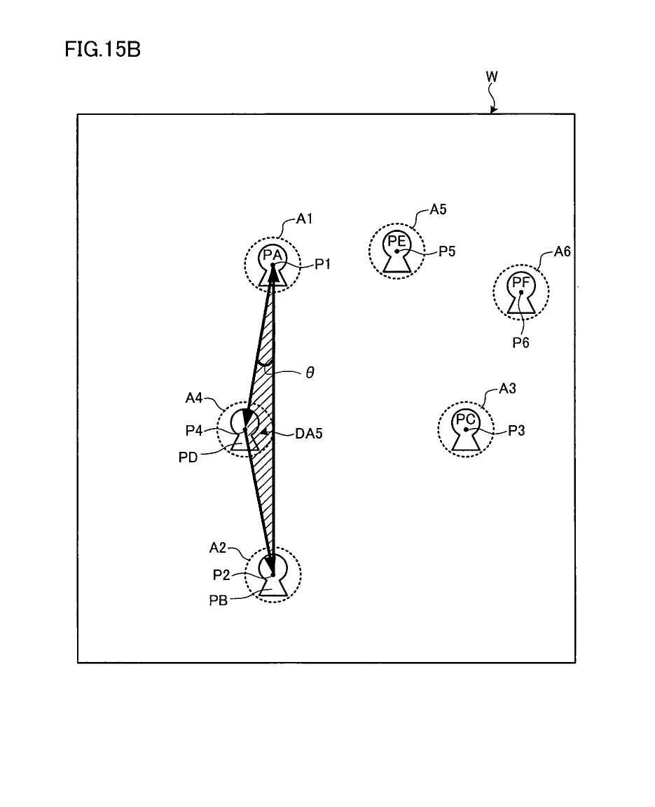

However, the player may touch the input determination area of an undesirable player character when performing a slide operation. FIG. 15A illustrates an example in which the player desires to form a triangle DA4 with vertices that respectively correspond to the positions P1, P2, and P3 of the player characters PA, PB, and PC. In this case, the player performs a slide operation that sequentially designates the player characters PA, PB, and PC by sequentially touching the input determination areas A1, A2, and A3, and returns to the initial area (input determination area A1). Note that the term “initial area” refers to the input determination area for which a touch operation was initially detected in the player's turn.

However, the player may unintentionally touch the input determination area A4 of the player character PD by mistake to designate the player character PD, for example.

In such a case, whether or not the interior angle θ of the vertex (position) P1 (i.e., the angle θ formed by a line that connects the positions P1 and P4 and a line that connects the positions P1 and P2) of a triangle DA5 with vertices that respectively correspond to the positions P1, P4, and P2 of the player characters PA, PD, and PB that have been designated sequentially is equal to or smaller than a predetermined angle (e.g., 15° is determined. When the angle θ is equal to or smaller than the predetermined angle, the designation of the second player character PD is canceled, and a triangle DA4 with vertices that respectively correspond to the positions P1, P2, and P3 of the player characters PA, PB, and PC is formed.

According to this configuration, even when the player has designated the player character PA, and then designated the player character PD by mistake, it is possible to cancel the designation of the player character PD, and form the triangle DA4 that is desired by the player (see FIG. 15A).

Note that the player may intentionally designate the player characters PA, PD, and PB by sequentially touching the input determination areas A1, A4, and A2 (see FIG. 15B). In such a case, the player performs the final input that returns to the initial position P1 since the player cannot designate the fourth player character. Specifically, the player sequentially designates the player characters PA, PD, and PB, and then touches the input determination area (initial area) A1 of the player character PA that was designated first (i.e., the final input is received) to form the triangle DA5 with vertices that respectively correspond to the positions P1, P4, and P2 of the player characters PA, PD, and PB.

### 3.9 Game Results

In one embodiment of the invention, either or both of a new item and a new character may be given to the player when the player character (player) has defeated the enemy character. In this case, the player can increase either or both of the number of player characters and the number of items possessed by the player by winning the game.

### 3.10 Placement of Player Character

In one embodiment of the invention, the player character that attacked the enemy character in the preceding player's turn is removed from the placement area in the current player's turn, and another player character among the player characters set to be the deck is placed within the placement area.

For example, when the player sets the player characters PA, PB, PC, PD, PE, PF, PG, PH, PI, PJ, PK, and PL to be the deck, and the player characters PA, PB, PC, PD, PE, and PF were placed within the placement area in the preceding player's turn, in which the triangle DA1 based on the positions of the player characters PA, PB, and PD and the triangle DA2 based on the positions of the player characters PA, PB, and PC were formed, and the player characters PA, PB, PC, and PD attacked the enemy character QA, the player characters PA, PB, PC, and PD are removed from the placement area in the subsequent player's turn, and the player characters PG, PH, PI, and PJ that have been randomly extracted from the player characters set to be the deck are placed within the placement area.

Specifically, a player character that attacked the enemy character in the preceding player's turn is replaced with another player character that was not placed within the placement area in the preceding player's turn.

### 3.11 Flowchart

(1) Game Process

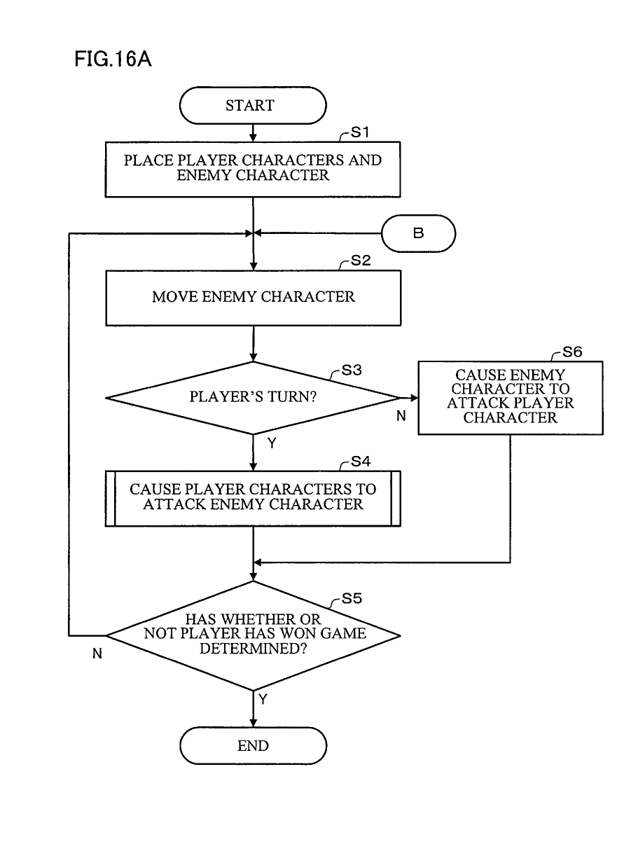

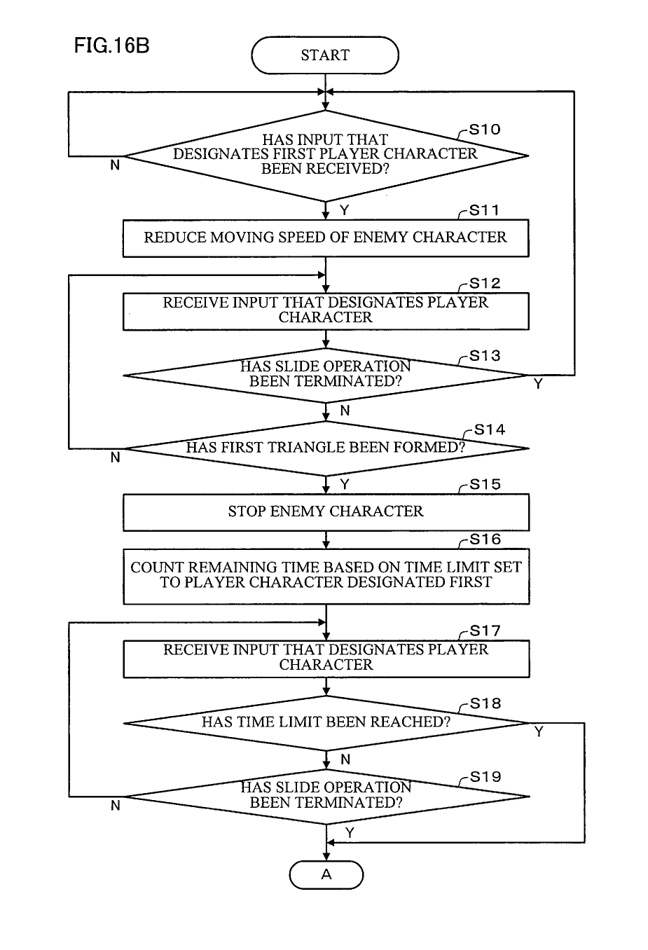

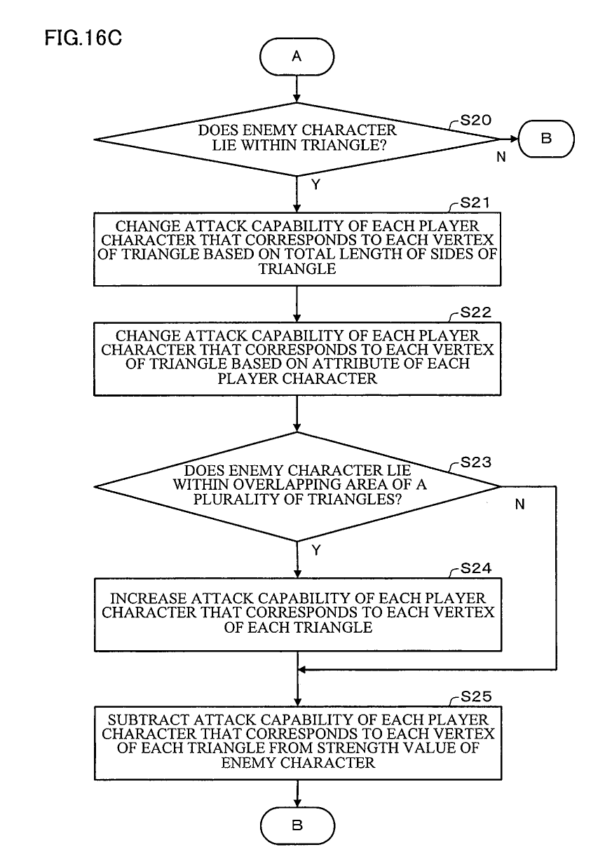

The flow of the game process according to one embodiment of the invention is described below with reference to FIGS. 16A to 16C.

The player characters and the enemy character are placed within the placement area (step S1). The enemy character is moved (step S2), and whether of not the player's turn has come is determined (step S3). When the player's turn has come (Y in step S3), the attack process that causes the player characters to attack the enemy character is performed (step S4).

The details of the attack process that causes the player characters to attack the enemy character (step S4) are described in detail below with reference to FIGS. 16B and 16C. As illustrated in FIG. 16B, whether or not an input that designates the first player character has been received is determined (step S10).

When an input that designates the first player character has been received (Y in step S10), the moving speed of the enemy character is reduced (step S11). An input that designates the second or subsequent player character is then received (step S12).

Whether or not the current slide operation has been terminated is determined (step S13). When the current slide operation has been terminated (Y in step S13), it is determined that the input that forms a triangle has been canceled, and the step S10 is performed again.

When the current slide operation has not been terminated (N in step S13), whether or not the first triangle has been formed is determined (step S14). When the first triangle has been formed (Y in step S14), the enemy character is stopped (step S15). When the first triangle has not been formed (N in step S14), the step S12 is performed again.

The remaining time is counted (measured) based on the time limit set to the player character that was designated first (step S16). An input that designates an arbitrary player character is received (step S17), and whether or not the time limit has been reached is determined (step S18). When the time limit has been reached (Y in step S18), a step S20 is performed.

When the time limit has not been reached (N in step S18), whether or not the current slide operation has been terminated is determined (step S19). When the current slide operation has been terminated (Y in step S19), the step S20 is performed. When the current slide operation has not been terminated (N in step S19), the step S17 is performed again.

As illustrated in FIG. 16C, whether or not the enemy character is present within the triangle formed by the player is determined (step S20).

When the enemy character is present within the triangle formed by the player (Y in step S20), the attack capability of each player character that corresponds to each vertex of the triangle is changed based on the total length of the sides of the triangle (step S21).

The attack capability of each player character that corresponds to each vertex of the triangle is changed based on the attribute of each player character (step S22).

Whether or not the enemy character is present within the overlapping area of a plurality of triangles is then determined (step S23). When the enemy character is present within the overlapping area of a plurality of triangles (Y in step S23), the attack capability of each player character that corresponds to each vertex of each triangle is increased (step S24). When the enemy character does not lie within the overlapping area of a plurality of triangles (N in step S23), a step S25 is performed.

The attack capability of each player character that corresponds to each vertex of each triangle is subtracted from the strength value of the enemy character (step S25), and the step S2 (see FIG. 16A) is performed again.

When the enemy character does not lie within the triangle formed by the player (N in step S20), the step S2 (see FIG. 16A) is performed again.

When the player's turn has not come (N in step S3), the attack process that causes the enemy character to attack each player character is performed (step S6) (see FIG. 16A). For example, the attack capability of the enemy character is subtracted from the strength value of each attack target player character. Whether or not the player has won the game is then determined (step S5). When whether or not the player has won the game has not been determined (N in step S5), the step S2 is performed again. When whether or not the player has won the game has been determined (Y in step S5), the process is terminated. The process is thus completed.

(2) Process that Forms a Triangle

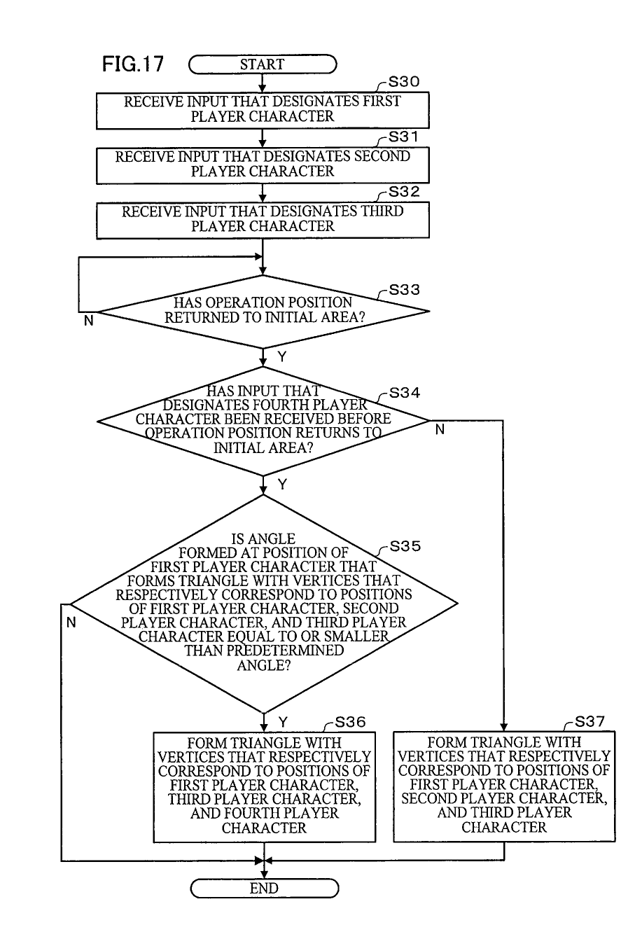

The process that forms a triangle is described below with reference to FIG. 17.

An input that designates the first player character is received (step S30). An input that designates the second player character is received (step S31). An input that designates the third player character is then received (step S32).

Whether or not the operation position has returned to the initial area is determined (step S33). When the operation position has returned to the initial area (Y in step S33), whether or not an input that designates the fourth player character has been received before the operation position returns to the initial area, is determined (step S34).

When an input that designates the fourth player character has been received before the operation position returns to the initial area (Y in step S34), whether or not the angle formed at the position (vertex) of the first player character that forms the triangle with vertices that respectively correspond to the positions of the first player character, the second player character, and the third player character is equal to or smaller than a predetermined angle is determined (step S35).

When the angle formed at the position (vertex) of the first player character that forms the triangle with vertices that respectively correspond to the positions of the first player character, the second player character, and the third player character is equal to or smaller than the predetermined angle (Y in step S35), a triangle with vertices that respectively correspond to the positions of the first player character, the third player character, and the fourth player character is formed (step S36).

When an input that designates the fourth player character has not been received before the operation position returns to the initial area (N in step S34), a triangle with vertices that respectively correspond to the positions of the first player character, the second player character, and the third player character is formed (step S37).

When the angle formed at the position (vertex) of the first player character that forms the triangle with vertices that respectively correspond to the positions of the first player character, the second player character, and the third player character is larger than the predetermined angle (N in step S35), the process is terminated. The process is thus completed.

### 4. Application Examples

The invention is not limited to the above embodiments. Various modifications and variations may be made of the above embodiments. Any term cited with a different term having a broader meaning or the same meaning at least once in the specification and the drawings may be replaced by the different term in any place in the specification and the drawings.

4.1 First Application Example of Process that Forms a Triangle

In one embodiment of the invention, the input direction may be detected based on a slide operation in a predetermined cycle (e.g., every 1/60th of a second), and the player characters may be designated based on the input direction v (input vector v) detected in the predetermined cycle to form a triangle with vertices that respectively correspond to the designated player characters.

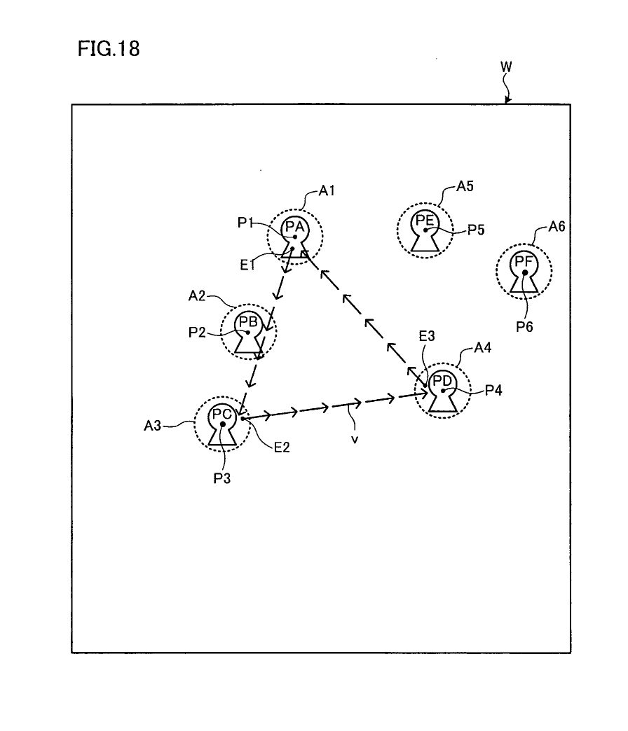

In the example illustrated in FIG. 18, when an input position E1 has been detected first within the touch detection area (touch panel), it is determined that the player character PA that corresponds to the input determination area A1 that includes the input position E1 has been designated as the first player character.

When a position (point) E2 at which the input direction (i.e., the direction of the input vector) changed has been detected within the touch detection area, it is determined that the player character PC that corresponds to the input determination area A3 that includes the position E2 has been designated as the second player character.

When a position (point) E3 at which the input direction changed has been detected within the touch detection area, it is determined that the player character PD that corresponds to the input determination area A4 that includes the position E3 has been designated as the third player character.

When the player characters PA, PC, and PD have thus sequentially been designated, a triangle with vertices that respectively correspond to the positions (points) P1, P3, and P4 of the player characters PA, PC, and PD is formed.

In one embodiment of the invention, the process that forms (completes) a triangle is performed at a timing at which the player has performed an input that designates the third player character, and then performed the final input (i.e., an input that touches the input determination area A1 of the player character PA that was designated first by performing a slide operation after designating the third player character PD).

According to this configuration, since the player character PB is not designated even when the player touched the input determination area A2 of the player character PB by mistake (see FIG. 18), it is possible to form a triangle that is desired by the player, for example.

Note that the input direction change point (position) is detected as described below. For example, it is determined that the input direction changed when the angle formed by an Nth vector v1 and an (N+1)th vector v2 (i.e., two input vectors v1 and v2 that are detected successively) detected in a predetermined cycle is equal to or larger than a predetermined angle (e.g., 15°). The starting point of the (N+1)th vector v2 is detected as the change point.

### 4.2 Correction of Input Determination Area

In one embodiment of the invention, the input determination area may be deformed based on the position of the player character that has been designated.

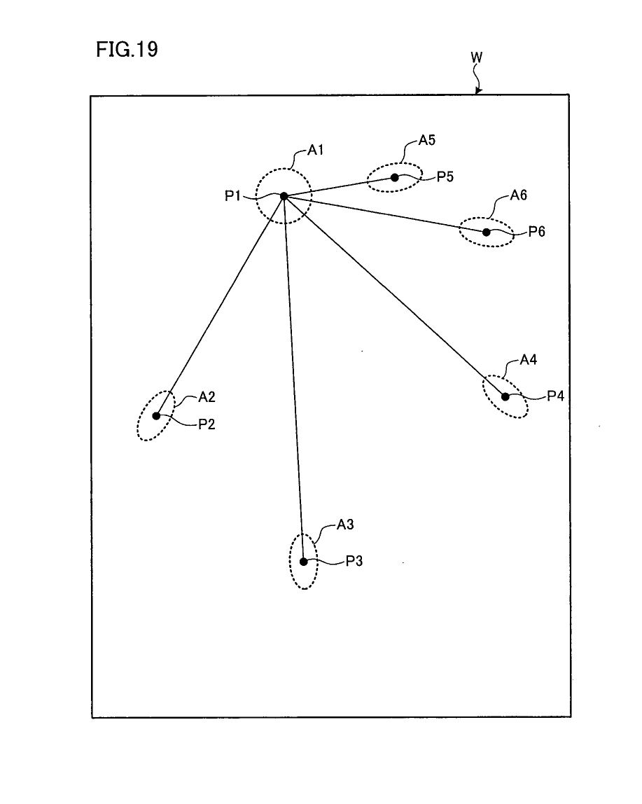

As illustrated in FIG. 19, the position P1 of the player character PA that has been designated is stored, for example. The input determination areas A2 to A6 of the player characters PB to PF other than the player character PA that has been designated are then deformed.

For example, the input determination area A2 of the player character PB is deformed so as to extend along a line (straight line) that connects the position P1 and the position P2 of the player character PB. For example, the input determination area A2 is deformed to have an elliptical shape, a rectangular shape, a linear shape, or the like instead of a circular shape. Specifically, the input determination area A2 is deformed to be narrow along the line that connects the position P1 and the position P2.

Likewise, the input determination areas A3 to A6 of the player characters PC to PF are deformed so as to extend along a line that connects the position P1 and the position of each player character.

This makes it possible to prevent a situation in which the player designates an undesired player character by mistake (i.e., it is possible to allow the player to designate the desired player character), and form a triangle that is desired by the player.

4.3 Process that Forms a Shape Other than a Triangle

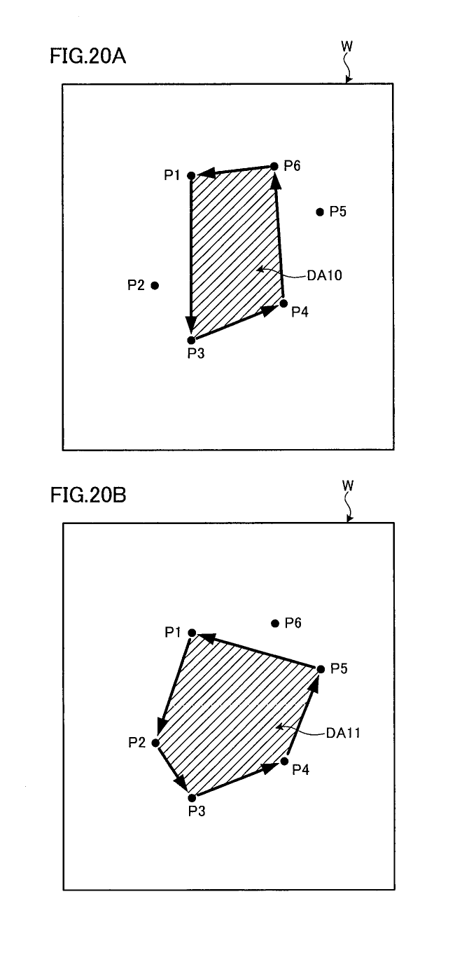

Although an example in which the player forms a triangle has been described above, the player may form a shape other than a triangle. For example, the player may form a quadrangle DA10 (see FIG. 20A) or a pentagon DA11 (see FIG. 20B). The player may form a heart-like shape, a star-like shape, or the like (not illustrated in the drawings) instead of a polygonal shape.

The attack capability of each player character may be changed based on the type of the shape that has been formed by the player. For example, the attack capability of each player character may be increased when the player has formed a heart-like shape as compared with the case where the player has formed a triangle.

### 4.4 Attack Capability of Enemy Character

In one embodiment of the invention, the attack capability of the enemy character may be changed based on at least one of the area and the total length of the sides of the triangle formed by the player.

For example, the attack capability (attack capability value) of the enemy character may be decreased when the enemy character's turn has come as the area of the triangle formed by the player decreases. The attack capability (attack capability value) of the enemy character may be decreased when the enemy character's turn has come as the total length of the sides of the triangle formed by the player decreases.

The attack capability of the enemy character may be changed based on the type of the shape that has been formed by the player. For example, the attack capability of the enemy character may be decreased when the enemy character's turn has come when the player has formed a heart-like shape as compared with the case where the player has formed a triangle.

When the player has formed a plurality of shapes, and the enemy character is present within the overlapping area of the plurality of shapes, the attack capability of the enemy character may be decreased (e.g., multiplied by 0.5) when the enemy character's turn has come.

### 4.5 Application Example of Game System

The game system according to one embodiment of the invention may be configured so that the server 20 implements almost all of the functions of the processing section 100 of the terminal.

For example, the game system may be implemented by cloud computing. When using cloud computing, the server stores, manages, and processes information (e.g., player information) about each player. Specifically, the terminal 10 transmits various types of input information input from the input section 160 to the server 20. The server 20 performs the process (e.g., the process that forms a triangle) of each section of the processing section 100 to generate image generation data for generating an image, and transmits the generated image generation data to each terminal. Note that the term “image generation data” used herein refers to data for displaying an image that has been generated using the method according to one embodiment of the invention on each terminal. The image generation data may be image data, or may be data (e.g., object data and game processing result data) that is used when each terminal generates an image. The game system may be configured so that the server and the terminal perform the process of each section of the processing section 100 by distributed processing.

4.6 Second Application Example of Process that Forms a Triangle

In one embodiment of the invention, a triangle may be formed as described below in order to prevent a situation in which an undesired player character is designated by the player by mistake (erroneous input).

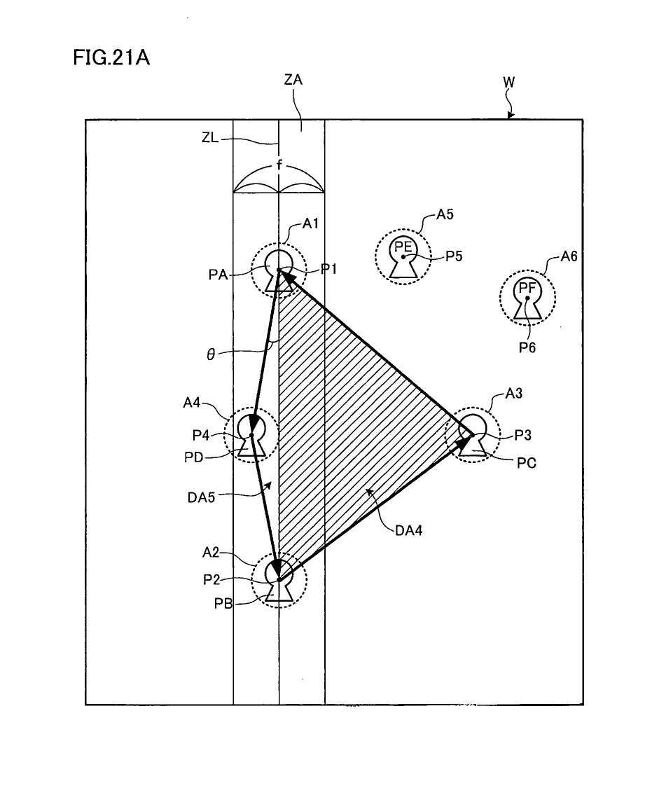

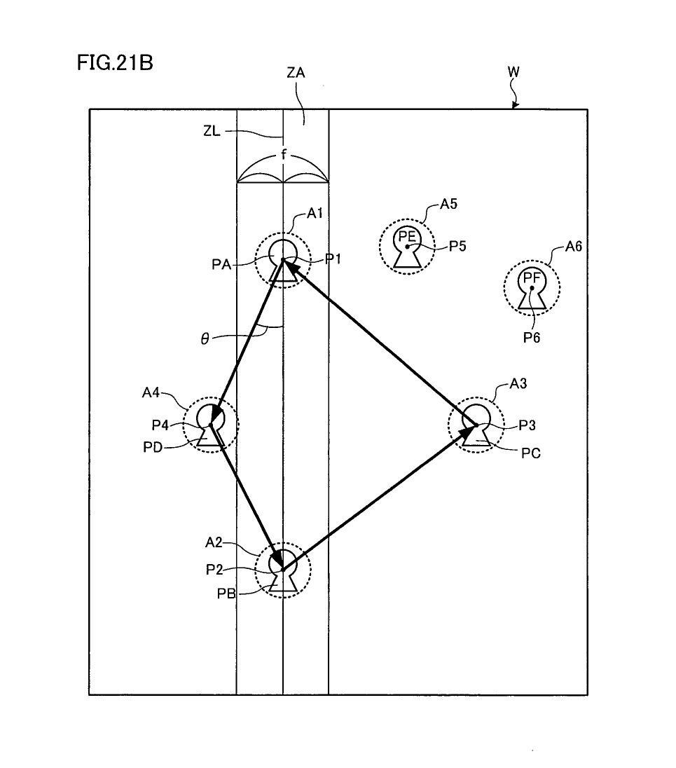

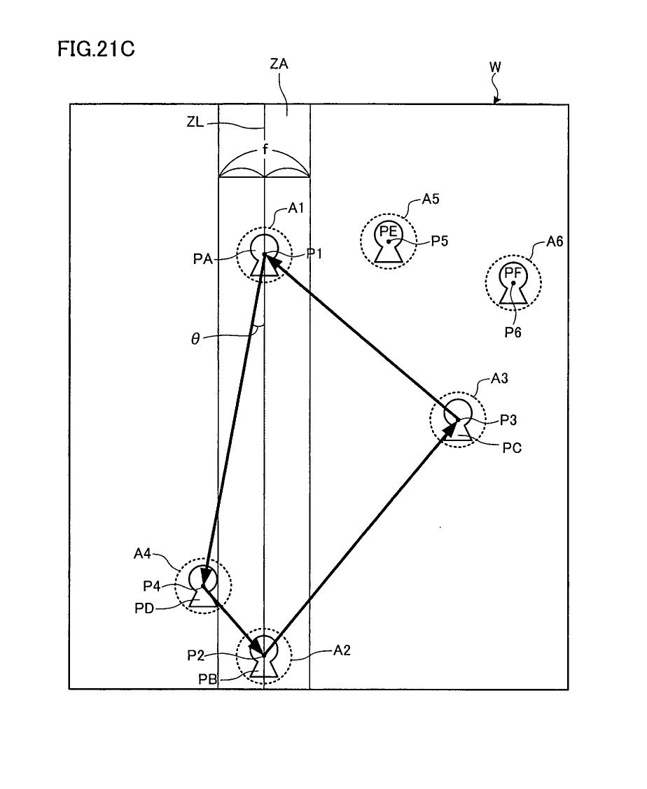

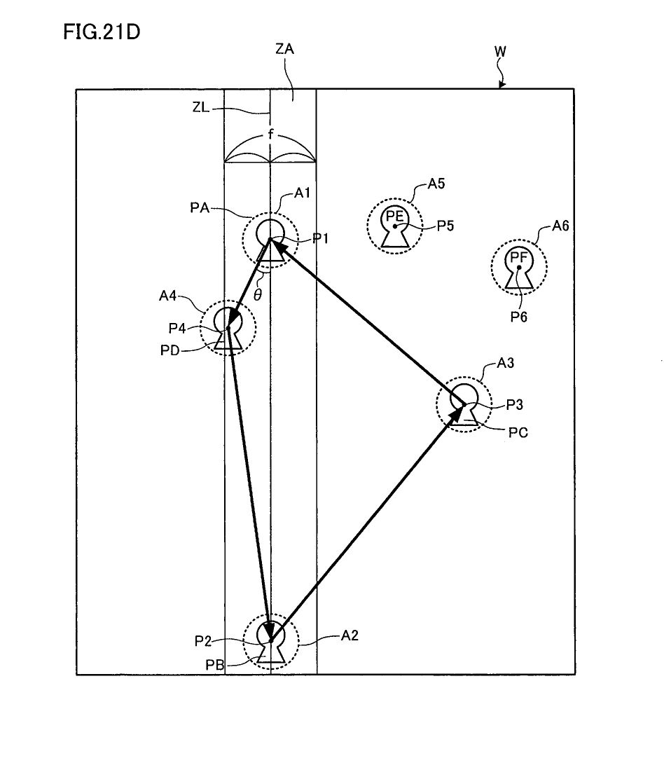

FIG. 21A illustrates an example in which the player who desires to form the triangle DA4 with vertices that respectively correspond to the positions P1, P2, and P3 of the player characters PA, PB, and PC has touched the input determination area A4 by mistake to designate the player character PD. Such a situation may be prevented by the following process.

Specifically, a determination area ZA is set to extend along a line that connects the position P1 of the player character PA (first player character) and the position P2 of the player character PB (third player character). For example, the determination area ZA is set to be a thick line (strip) that has a thickness f and extends along a line ZL (center axis) that connects the position P1 and the position P2. Note that the thickness f is set to be equal to or slightly larger than the diameter of the input determination area set to each player character, for example.

When the position P4 of the player character PD (that has been designated after the first player character) is present within the determination area ZA, the designation of the player character PD is canceled, and the triangle DA4 with vertices that respectively correspond to the positions P1, P2, and P3 of the player characters PA, PB, and PC (i.e., first player character, third player character, and fourth player character) is formed.

According to this configuration, even when the player has designated the player character PA, and then designated the player character PD by mistake, it is possible to cancel the designation of the player character PD, and form the triangle DA4 that is desired by the player (see FIG. 21A).

When the position P4 of the player character PD (that has been designated after the first player character) does not lie within the determination area ZA (see FIG. 21B), the designation of the player character PD is maintained (i.e., it is determined that the player has intentionally designated the player character PD).

A triangle may be formed as described below in order to more reliably prevent a situation in which an undesired player character is designated by the player by mistake (erroneous input). Specifically, when a first condition (a) whereby the angle (interior angle) θ formed by a line that connects the position P1 of the player character PA (first player character) and the position P4 of the player character PD (second player character), and a line that connects the position P1 of the player character PA and the position P2 of the player character PB (third player character), is equal to or smaller than a predetermined angle (e.g., 15°), is satisfied, and a second condition (b) whereby the position P4 of the player character PD (second player character) is present within the determination area ZA that extends along a line that connects the position P1 of the player character PA (first player character) and the position P2 of the player character PB (third player character), is satisfied (see FIG. 21A), the designation of the player character PD (second player character) is canceled. When the first condition (a) whereby the angle θ is equal to or smaller than the predetermined angle is not satisfied, and the second condition (b) whereby the position P4 of the player character PD (second player character) is present within the determination area ZA is not satisfied (see FIG. 21B), the designation of the player character PD is maintained (i.e., it is determined that the player has intentionally designated the player character PD). When the first condition (a) whereby the angle θ is equal to or smaller than the predetermined angle is satisfied, and the second condition (b) whereby the position P4 of the player character PD (second player character) is present within the determination area ZA is not satisfied (see FIG. 21C), the designation of the player character PD is maintained (i.e., it is determined that the player has intentionally designated the player character PD). When the first condition (a) whereby the angle θ is equal to or smaller than the predetermined angle is not satisfied, and the second condition (b) whereby the position P4 of the player character PD (second player character) is present within the determination area ZA is satisfied (see FIG. 21D), the designation of the player character PD is maintained (i.e., it is determined that the player has intentionally designated the player character PD).

When four player characters PA, PD, PB, and PC have been designated (see FIGS. 21B, 21C, and 21D), a triangle is not formed since the vertices of a triangle cannot be determined Note that a triangle with vertices that respectively correspond to the positions of the first player character, the second player character, and the third player character may be formed when four player characters have been designated by ignoring the fourth character.

4.7 Third Application Example of Process that Forms a Triangle

In one embodiment of the invention, when the player has performed a slide operation that designates the player character PC first, designates the player character PA after the player character PC, designates the player character PD by mistake after the player character PA, designates the player character PB after the player character PD, and returns to the initial area (input determination area A3) (see FIG. 15A), for example, a triangle with vertices that respectively correspond to the positions P3, P1, and P2 of the player characters PC, PA, and PB may also be formed.

For example, whether or not the angle (interior angle) θ formed by a line that connects the position P1 of the player character PA (second player character) and the position P4 of the player character PD (third player character), and a line that connects the position P1 of the player character PA (second player character) and the position P2 of the player character PB (fourth player character), is equal to or smaller than a predetermined angle (e.g., 15°), is determined at a timing at which the player character PB (fourth player character) has been designated. When the angle θ is equal to or smaller than the predetermined angle, the designation of the player character PD (third player character) is canceled, and the triangle DA4 with vertices that respectively correspond to the positions P3, P1, and P2 of the player characters PC, PA, and PB (first player character, second player character, and fourth player character) is formed.

According to this configuration, even when the player has designated the player character PD by mistake, it is possible to cancel the designation of the player character PD, and form the triangle DA4 that is desired by the player (see FIG. 15A).

When the player has performed a slide operation that designates the player character PC first, designates the player character PA after the player character PC, designates the player character PD by mistake after the player character PA, designates the player character PB after the player character PD, and returns to the initial area (input determination area A3) (see FIG. 21A), the determination area ZA may be set, and the triangle DA4 may be formed.

For example, the determination area ZA is set to extend along a line that connects the position P1 of the player character PA (second player character) and the position P2 of the player character PB (fourth player character) at a timing at which the player character PB (fourth player character) has been designated (see FIG. 21A). For example, the determination area ZA is set to be a thick line (strip) that has a thickness f and extends along the line ZL (center axis) that connects the position P1 and the position P2.

When the position P4 of the player character PD (third player character) is present within the determination area ZA, the designation of the player character PD (third player character) is canceled, and the triangle DA4 with vertices that respectively correspond to the positions P3, P1, and P2 of the player characters PC, PA, and PB (i.e., first player character, second player character, and fourth player character) is formed.

According to this configuration, even when the player has designated the player character PA, and then designated the player character PD by mistake, it is possible to cancel the designation of the player character PD, and form the triangle DA4 that is desired by the player (see FIG. 21A).

When a first condition whereby the angle (interior angle) θ formed by a line that connects the position P1 of the player character PA (second player character) and the position P4 of the player character PD (third player character), and a line that connects the position P1 of the player character PA (second player character) and the position P2 of the player character PB (fourth player character), is equal to or smaller than a predetermined angle (e.g., 15°), is satisfied at a timing at which the player character PB (fourth player character) has been designated, and a second condition whereby the position P4 of the player character PD (third player character) is present within the determination area ZA is satisfied, the designation of the player character PD (third player character) may be canceled.

4.8 Fourth Application Example of Process that Forms a Triangle

When foul player characters have been designated, a triangle is basically not formed since the vertices of a triangle cannot be determined. Note that a triangle may be formed when the designation of one of the four player characters can be canceled as described below.

For example, when the player has performed a slide operation that designates the player character PB first, designates the player character PC after the player character PB, designates the player character PA after the player character PC, designates the player character PD by mistake after the player character PA, and returns to the initial area (input determination area A3) (see FIG. 15A), the triangle DA4 with vertices that respectively correspond to the positions P2, P3, and P1 of the player characters PB, PC, and PA may be formed.

For example, whether or not the angle (interior angle) θ formed by a line that connects the position P1 of the player character PA (third player character) and the position P4 of the player character PD (fourth player character), and a line that connects the position P1 of the player character PA (third player character) and the position P2 of the player character PB (first player character), is equal to or smaller than a predetermined angle (e.g., 15°), is determined at a timing at which the player character PD (fourth player character) has been designated. When the angle θ is equal to or smaller than the predetermined angle, the designation of the player character PD (fourth player character) is canceled, and the triangle DA4 with vertices that respectively correspond to the positions P2, P3, and P1 of the player characters PB, PC, and PA (first player character, second player character, and third player character) is formed.

According to this configuration, even when the player has designated the player character PD by mistake, it is possible to cancel the designation of the player character PD, and form the triangle DA4 that is desired by the player (see FIG. 15A).

When the player has performed a slide operation that designates the player character PB first, designates the player character PC after the player character PB, designates the player character PA after the player character PC, designates the player character PD by mistake after the player character PA, and returns to the initial area (input determination area A2) (see FIG. 21A), the determination area ZA may be set, and the triangle DA4 may be formed.

For example, the determination area ZA is set to extend along a line that connects the position P1 of the player character PA (third player character) and the position P2 of the player character PB (first player character) at a timing at which the player character PD (fourth player character) has been designated (see FIG. 21A). For example, the determination area ZA is set to be a thick line (strip) that has a thickness f and extends along the line ZL (center axis) that connects the position P1 and the position P2.

When the position P4 of the player character PD (fourth player character) is present within the determination area ZA, the designation of the player character PD (fourth player character) is canceled, and the triangle DA4 with vertices that respectively correspond to the positions P2, P3, and P1 of the player characters PB, PC, and PA (i.e., first player character, second player character, and third player character) is formed.

According to this configuration, even when the player has designated the player character PA, and then designated the player character PD by mistake, it is possible to cancel the designation of the player character PD, and form the triangle DA4 that is desired by the player (see FIG. 21A).

When a first condition whereby the angle (interior angle) θ formed by a line that connects the position P1 of the player character PA (third player character) and the position P4 of the player character PD (fourth player character), and a line that connects the position P1 of the player character PA (third player character) and the position P2 of the player character PB (first player character), is equal to or smaller than a predetermined angle (e.g., 15°), is satisfied at a timing at which the player character PD (fourth player character) has been designated, and a second condition whereby the position P4 of the player character PD (fourth player character) is present within the determination area ZA is satisfied, the designation of the player character PD (fourth player character) may be canceled.

### 5. Process that Forms a Plurality of Shapes and Attack Process when a Plurality of Enemy Characters Exist

In one embodiment of the invention, a plurality of shapes may be formed during the player's turn so that a plurality of enemy characters can be attacked.

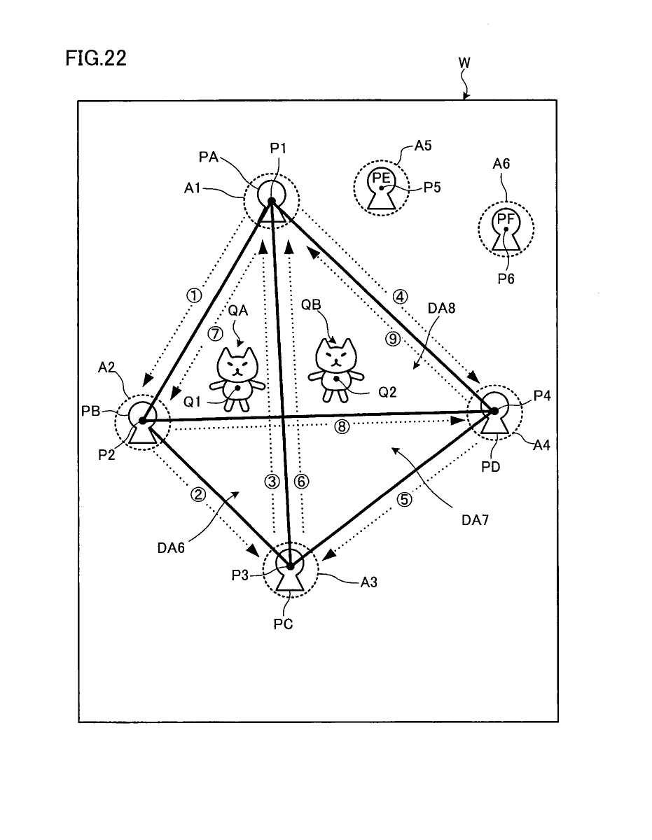

As illustrated in FIG. 22, a triangle DA6 may be formed to surround the enemy character QA, a triangle DA7 may be formed to surround the enemy character QB, and a triangle DA8 may be formed to surround the enemy characters QA and QB during the player's turn to effect the attack process, for example.

Specifically, the player characters PA, PB, and PC are sequentially designated based on a slide operation performed by the player, and the triangle DA6 with vertices that respectively correspond to the positions P1, P2, and P3 of the player characters PA, PB, and PC is formed.

The player characters PA, PD, and PC are sequentially designated within the limited time corresponding to the player character PA that has been designated first by a slide operation performed by the player immediately after the triangle DA6 has been formed, and the triangle DA7 with vertices that respectively correspond to the positions P1, P4, and P3 of the player characters PA, PD, and PC is formed.

The player characters PA, PB, and PD are sequentially designated within the limited time corresponding to the player character PA by a slide operation performed by the player immediately after the triangle DA7 has been formed, and the triangle DA8 with vertices that respectively correspond to the positions P1, P2, and P4 of the player characters PA, PB, and PD is formed. The time limit is then reached.

In this case, since the enemy character QA is present within the triangle DA6, the process that causes the player characters PA, PB, and PC that correspond to the vertices (P1, P2, and P3) of the triangle DA6 to attack the enemy character QA is performed.

Since the enemy character QB is present within the triangle DA7, the process that causes the player characters PA, PD, and PC that correspond to the vertices (P1, P4, and P3) of the triangle DA7 to attack the enemy character QB is performed.

Since the enemy characters QA and QB lie within the triangle DA8, the process that causes the player characters PA, PB, and PD that correspond to the vertices (P1, P2, and P4) of the triangle DA8 to attack the enemy characters QA and QB is performed.

In the example illustrated in FIG. 22, since the enemy character QA is present within the overlapping area of the triangles DA6 and DA8, the attack capability of the player characters PA, PB, and PC that correspond to the vertices (P1, P2, and P3) of the triangle DA6 may be increased (e.g., multiplied by 1.5), and the attack capability of the player characters PA, PB, and PD that correspond to the vertices (P1, P2, and P4) of the triangle DA8 may be increased (e.g., multiplied by 1.5). Since the enemy character QB is present within the overlapping area of the triangles DA7 and DA8, the attack capability of the player characters PA, PD, and PC that correspond to the vertices (P1, P4, and P3) of the triangle DA7 may be increased (e.g., multiplied by 1.5), and the attack capability of the player characters PA, PB, and PD that correspond to the vertices (P1, P2, and P4) of the triangle DA8 may be increased (e.g., multiplied by 1.5).

According to this configuration, the player can enjoy strategic game play while forming a triangle that surrounds a plurality of enemy characters, or forming a number of triangles, for example.

Although only some embodiments of the invention have been described in detail above, those skilled in the art would readily appreciate that many modifications are possible in the embodiments without materially departing from the novel teachings and advantages of the invention. Accordingly, all such modifications are intended to be included within the scope of the invention.

What is claimed is:

1. A non-transitory computer-readable information storage medium storing a program that implements a game process that causes a plurality of player characters to battle with an enemy character, the program causing a computer to function as:
a placement section that places the player characters and the enemy character in a placement area;
a reception section that receives a shape input that sequentially designates a predetermined number of player characters among the plurality of player characters to form a predetermined shape;
a determination section that determines whether or not the predetermined shape has been formed based on the shape input;
an enemy character control section that controls movement of the enemy character;
an enemy character determination section that determines whether or not the enemy character is present within an area defined by the formed shape; and
a battle processing section that performs a process that causes the designated player characters to attack the enemy character when the enemy character is present within the area.

2. The information storage medium as defined in claim 1,
wherein a time for receiving the shape input is limited corresponding to each of the player characters; and
wherein the reception section receives the shape input within the limited time corresponding to the designated player characters.

3. The information storage medium as defined in claim 2,
wherein the reception section starts to count the limited time when the determination section has determined that a first shape has been formed.

4. The information storage medium as defined in claim 2,
wherein a position of one of the designated player characters that has been designated first is a starting point; and
wherein, when the determination section has determined that a first shape has been formed by the shape input, the reception section repeatedly receives the shape inputs having the same starting point within the limited time.

5. The information storage medium as defined in claim 1,
wherein, when the shape input has been suspended before the determination section determines that a first shape has been formed, the reception section cancels the shape input that has been performed before the suspension.

6. The information storage medium as defined in claim 1,
wherein the enemy character control section reduces a moving speed of the enemy character when a first input that designates one of the player characters has been received, and stops the enemy character when the determination section has determined that a first shape has been formed.

7. The information storage medium as defined in claim 1,
wherein the program causes the computer to further function as a parameter control section that changes at least one of an attack capability of the player characters and an attack capability of the enemy character based on an area of the formed shape.

8. The information storage medium as defined in claim 1,
wherein the program causes the computer to further function as a parameter control section that changes at least one of an attack capability of the player characters and an attack capability of the enemy character based on a total length of sides of the formed shape.

9. The information storage medium as defined in claim 1,
wherein the program causes the computer to further function as a parameter control section that changes at least one of an attack capability of the player characters and an attack capability of the enemy character based on a type of the formed shape.

10. The information storage medium as defined in claim 1,
wherein the program causes the computer to further function as a parameter control section that changes at least one of an attack capability of the player characters and an attack capability of the enemy character when a plurality of shapes have been formed and the enemy character is present within an overlapping area of the plurality of shapes.

11. A terminal that implements a game process that causes a plurality of player characters to battle with an enemy character, the terminal comprising:
a placement section that places the player characters and the enemy character in a placement area;
a reception section that receives a shape input that sequentially designates a predetermined number of player characters among the plurality of player characters to form a predetermined shape;
a determination section that determines whether or not the predetermined shape has been formed based on the shape input;
an enemy character control section that controls movement of the enemy character;
an enemy character determination section that determines whether or not the enemy character is present within an area defined by the formed shape; and
a battle processing section that performs a process that causes the designated player characters to attack the enemy character when the enemy character is present within the area.
